(19) United States
(12) Patent Application Publication
(10) Pub. No.: US 2026/0278404 A1
(43) Pub. Date: Sep. 17, 2026

(54) INFORMATION PROCESSING METHOD AND APPARATUS

(71) Applicant: MAXELL, LTD., Kyoto (JP)

(72) Inventor: Takuya SHIMIZU, Kyoto (JP)

(21) Appl. No.: 19/565,967

(22) Filed: Mar. 13, 2026

(30) Foreign Application Priority Data
Mar. 14, 2025 (JP) 2025-041713

(51) Int. Cl. G06N 5/02; G06F 3/04842; G06N 5/04

(52) U.S. Cl. CPC G06N 5/02; G06F 3/04842; G06N 5/04

(57) ABSTRACT

An information processing system and method for retrieval-augmented generation includes an original data storage step of acquiring original data for retrieval-augmented generation and storing the acquired original data in an original data storage; a knowledge base generation step of performing embedding processing for retrieval-augmented generation based on the original data stored in the original data storage to generate knowledge base data including embedded data, and storing the knowledge base data in a knowledge base storage to generate a knowledge base; a selection information output step of outputting, to a user, selection information that allows the user to select whether to delete or keep the original data stored in the original data storage after the embedding processing; and a control step of controlling deleting or keeping the original data stored in the original data storage based on a selection made by the user with respect to the selection information.

### CROSS-REFERENCE TO RELATED APPLICATION

The present application claims priority from Japanese Patent Application No. 2025-041713 filed on Mar. 14, 2025, the contents of which are hereby incorporated by reference into this application.

### TECHNICAL FIELD

The present invention relates to an information processing technique.

### BACKGROUND

Japanese Patent Application Laid-Open Publication No. 2019-528512 (Patent Document 1) discloses a response output technique using artificial intelligence such as language models.

### SUMMARY

However, Patent Document 1 fails to sufficiently consider, for example, a configuration to more suitably provide a user with a response output technique using artificial intelligence.

Therefore, an object of the present invention is to provide a more suitable response output technique.

In order to solve the above-described problem, a configuration described in, for example, the attached claims is adopted. The present application includes a plurality of measures for solving the above-described problem, one such example being an information processing method executed by a system configured to perform information processing for retrieval-augmented generation. The method includes: an original data storage step of acquiring original data for retrieval-augmented generation and storing the acquired original data in an original data storage; a knowledge base generation step of performing embedding processing for retrieval-augmented generation based on the original data stored in the original data storage to generate knowledge base data including embedded data, and storing the knowledge base data in a knowledge base storage to generate a knowledge base; a selection information output step of outputting, to a user, selection information that allows the user to select whether to delete or keep the original data stored in the original data storage after the embedding processing; and a control step of controlling deleting or keeping the original data stored in the original data storage based on a selection made by the user with respect to the selection information.

According to the present invention, a more suitable response output technique can be provided. Other problems, configurations and effects will become apparent from the following description of the embodiments.

### DRAWINGS

FIG. 1A is a drawing showing an example of an artificial intelligence response output apparatus and system according to an embodiment of the present invention.

FIG. 1B is a drawing showing an example of the artificial intelligence response output apparatus according to the embodiment of the present invention.

FIG. 1C is a drawing showing an example of the artificial intelligence response output apparatus according to the embodiment of the present invention.

FIG. 1D is a drawing showing an example of a server according to the embodiment of the present invention.

FIG. 1E is an explanatory diagram of an example of an artificial intelligence response output system according to the embodiment of the present invention.

FIG. 2A is an explanatory diagram of an example of the artificial intelligence response output apparatus and system according to the embodiment of the present invention.

FIG. 2B is an explanatory diagram of an example of a mobile information processing terminal according to the embodiment of the present invention.

FIG. 2C is an explanatory diagram of an example of an operation of the artificial intelligence response output apparatus and system according to the embodiment of the present invention.

FIG. 2D is an explanatory diagram of an example of the operation of the artificial intelligence response output apparatus and system according to the embodiment of the present invention.

FIG. 2E is an explanatory diagram of a display example of the artificial intelligence response output apparatus according to the embodiment of the present invention.

FIG. 3A is an explanatory diagram of a configuration of retrieval-augmented generation (RAG) implemented in a system including the artificial intelligence response output apparatus according to the embodiment of the present invention.

FIG. 3B is an explanatory diagram of an example of pre-processing for the configuration of retrieval-augmented generation (RAG) implemented in the system including the artificial intelligence response output apparatus according to the embodiment of the present invention.

FIG. 3C is an explanatory diagram of an example of conversations with the LLM using retrieval-augmented generation (RAG) in the system including the artificial intelligence response output apparatus according to the embodiment of the present invention.

FIG. 3D is an explanatory diagram showing multiple configuration examples relating to the arrangement of components of the retrieval-augmented generation (RAG) and the LLM in the system including the artificial intelligence response output apparatus according to the embodiment of the present invention, summarized in a table.

FIG. 3E is explanatory diagram showing whether or not a first function or a second function is implemented for each configuration example in the system including the artificial intelligence response output apparatus according to the embodiment of the present invention, summarized in a table.

FIG. 3F is an explanatory diagram showing a first example of displaying on a screen relating to embedding processing (displaying a menu for confirming deletion of original data) by the first function in the system including the artificial intelligence response output apparatus according to the embodiment of the present invention.

FIG. 3G is an explanatory diagram showing a second example of displaying on the screen relating to embedding processing (displaying the menu for confirming deletion of the original data) by the first function in the system including the artificial intelligence response output apparatus according to the embodiment of the present invention.

FIG. 3H is an explanatory diagram showing a third example of displaying on the screen relating to embedding processing (displaying the menu for confirming deletion of the original data) by the first function in the system including the artificial intelligence response output apparatus according to the embodiment of the present invention.

FIG. 3I is an explanatory diagram showing a first example relating to original data acquisition control processing by the second function in the system including the artificial intelligence response output apparatus according to the embodiment of the present invention.

FIG. 3J is an explanatory diagram showing a second example relating to original data acquisition control processing by the second function in the system including the artificial intelligence response output apparatus according to the embodiment of the present invention.

FIG. 3K is an explanatory diagram showing a configuration example implementing retrieval-augmented generation (RAG) in the mobile information processing terminal in the system including the artificial intelligence response output apparatus according to the embodiment of the present invention.

### PREFERRED EMBODIMENTS

Hereinafter, embodiments of the present invention will be described in detail with reference to the drawings. Note that the present invention is not limited to the embodiment described herein, and various changes and modifications can be made by those skilled in the art without departing from the scope of technical concepts disclosed herein. In addition, in all of the drawings used to describe the present invention, components having identical functions may be denoted by the same reference sign, and redundant descriptions thereof may be omitted as appropriate.

Note that an artificial intelligence response output apparatus according to each embodiment of the present invention having a display screen may also be referred to as a display apparatus. The artificial intelligence response output apparatus having an audio output function may also be referred to as an audio output apparatus. The artificial intelligence response output apparatus may also simply be referred to as an information processing apparatus. A system including the artificial intelligence response output apparatus and a large language model server that holds a large language model may also be referred to as an artificial intelligence response output system. In addition, in a case where the artificial intelligence response output apparatus provides a response service of a large language model which is artificial intelligence to the user to assist the user, the artificial intelligence response output apparatus or a display output of the artificial intelligence response output apparatus can be an artificial intelligence (AI) assistant for the user. Therefore, in this case, the artificial intelligence response output apparatus may also be referred to as an AI assistant apparatus or an AI assistant display apparatus. Likewise, in this case, a system including the artificial intelligence response output apparatus and a large language model server that holds a large language model may also be referred to as an AI assistant system or an AI assistant display system. In addition, in this case, the artificial intelligence response output apparatus serves as an interface between the user and the artificial intelligence and thus may also be referred to as an artificial intelligence interface apparatus. In this case, a system including the artificial intelligence response output apparatus and a large language model server that holds a large language model may also be referred to as an artificial intelligence interface system.

### First Embodiment

Hereinafter, an artificial intelligence response output apparatus and system that outputs a response from a large language model artificial intelligence will be described as a first embodiment of the present invention.

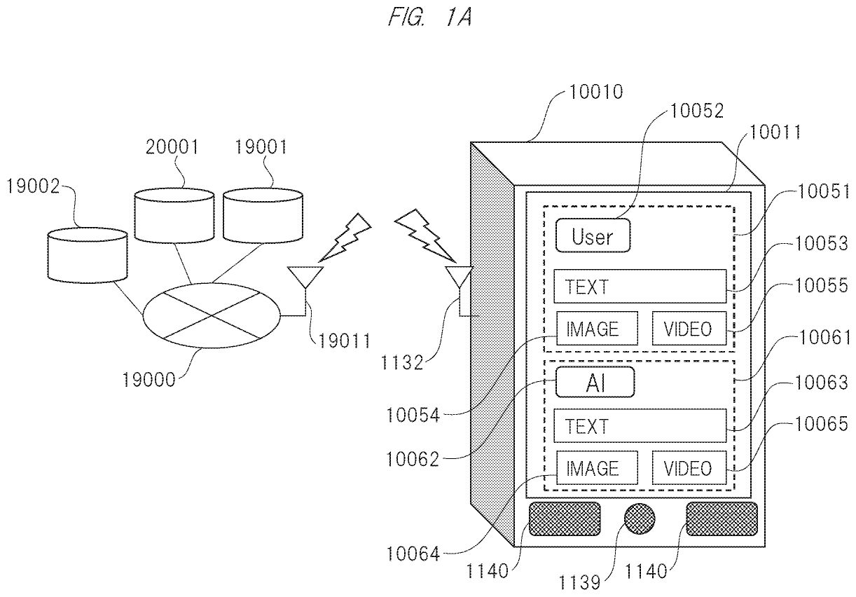

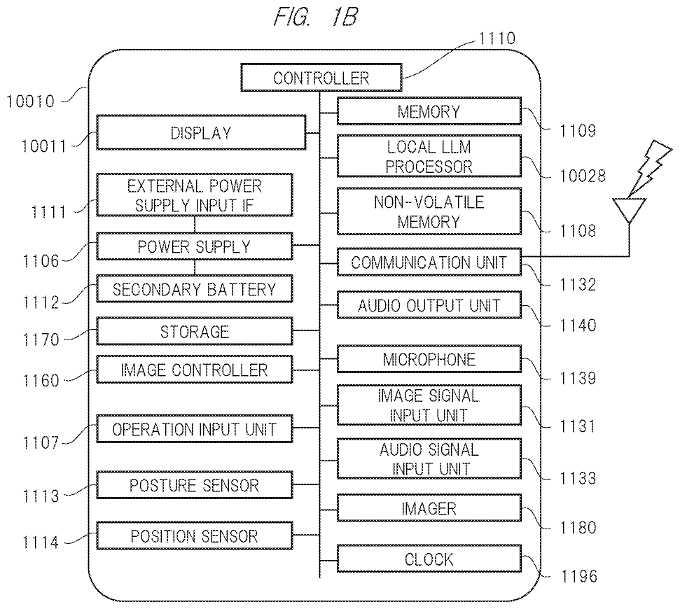

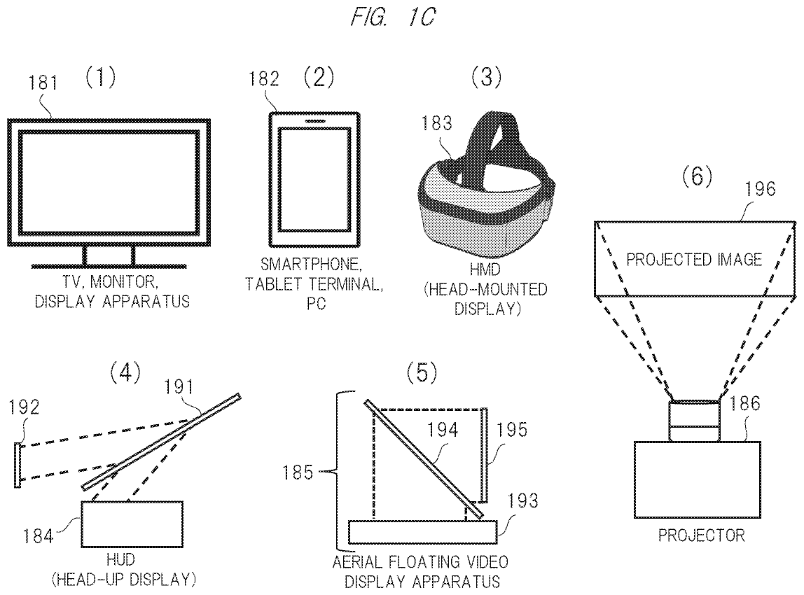

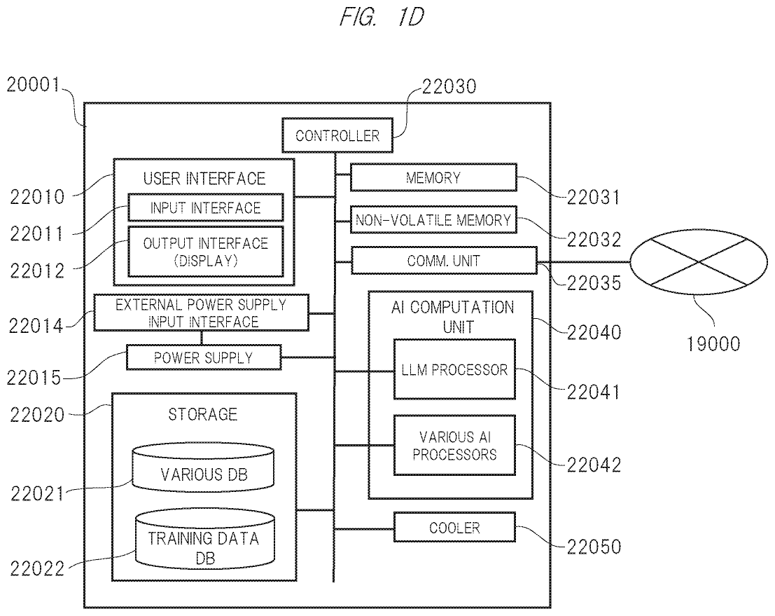

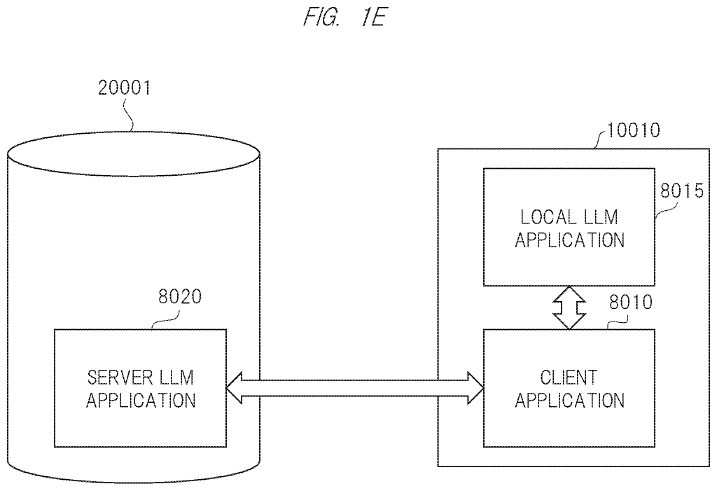

Hereinafter, an example of an artificial intelligence response output apparatus 10010 of the present invention will be described with reference to FIG. 1A. In addition, an example of a system including an artificial intelligence response output apparatus 10010 and a large language model server 19001 and/or a multimodal large language model server 20001 in a case where the artificial intelligence response output apparatus 10010 cooperates with the large language model server 19001 and/or the multimodal large language model server 20001 through communication or the like will be described.

In the example of FIG. 1A, the artificial intelligence response output apparatus 10010 has a display 10011. In the example of FIG. 1A, the display 10011 may be a flat panel display, a screen that projects an image from a rear surface, or an aerial floating video formed in midair by an optical image. In a case where the display 10011 is a flat panel display, the display may be a liquid crystal display having a liquid crystal panel and a backlight. In addition, the display 10011 may be a plasma display. The display 10011 may be an organic EL display in which pixels emit light. In addition, the display 10011 may be provided with a touch operation input sensor configured as a touch panel.

In the example of FIG. 1A, an audio output unit 1140 of the artificial intelligence response output apparatus 10010 is configured with a speaker. In addition, the artificial intelligence response output apparatus 10010 comprises a microphone 1139 capable of capturing a user's voice. Using audio input from the microphone 1139 or an operation input of the user via an operation input unit described below, the artificial intelligence response output apparatus 10010 can acquire user input that is the basis of a prompt for the large language model which is artificial intelligence.

The artificial intelligence response output apparatus 10010 may comprise a local large language model. In this case, a response of the large language model may be output as display output on the above-described display 10011 and/or as audio output of the audio output unit 1140.

In addition, the artificial intelligence response output apparatus 10010 may not comprise the local large language model, but may communicate with an external large language model server 19001 and/or a multimodal large language model server 20001, and may output the response received from the large language model server 19001 and/or the multimodal large language model server 20001 as display output of the above-described display 10011 and/or as audio output of the audio output unit 1140.

Alternatively, the artificial intelligence response output apparatus 10010 may be further configured to communicate with the external large language model server 19001 having a large language model, or the external large language model server 20001 having a multimodal large language model in addition to comprising the local large language model. In this case, a response of the local large language model and a response received from the large language model of the large language model server 19001 or from the multimodal large language model of the multimodal large language model server 20001 may be switched, and either of the responses may be output as display output of the above-described display 10011 and/or as audio output of the audio output unit 1140. Alternatively, a response generated based on both the response of the local large language model and the response received from the large language model of the large language model server 19001 or the multimodal large language model of the multimodal large language model server 20001 may be output as display output of the above-described display 10011 and/or as audio output of the audio output unit 1140.

A configuration where the artificial intelligence response output apparatus 10010 communicates and cooperates with the external large language model server 19001 or the large language model server 20001 is as follows. The artificial intelligence response output apparatus 10010 can communicate with a communication apparatus 19011 connected to the Internet 19000 via a communication unit 1132. The example of FIG. 1A shows a wireless communication between the communication unit 1132 and the communication apparatus 19011. However, the communication may be a wired communication. A communication path between the communication unit 1132 and the communication apparatus 19011 may include both wired and wireless portions, and may pass through a router or a repeater. The artificial intelligence response output apparatus 10010 can communicate with the large language model server 19001 or the large language model server 20001 and a second server 19002 that differs from these servers via the communication apparatus 19011 and the Internet 19000. A configuration including the artificial intelligence response output apparatus 10010 and the large language model server 19001 or the large language model server 20001 may be considered as a single system.

In the following description, unless otherwise specified, the expression “large language model” may be considered to be a concept that includes the local large language model of the artificial intelligence response output apparatus 10010, the large language model of the large language model server 19001, and the multimodal large language model of the large language model server 20001.

The example of FIG. 1A shows the display 10011 displaying each element in two display regions, one being a prompt display region 10051 in which the user inputs a prompt to the large language model which is artificial intelligence, and the other being an artificial intelligence response display region 10061 for displaying the response from the large language model. The example of FIG. 1A shows the prompt display region 10051 displaying, for example, an icon 10052 indicating the user, text 10053 such as natural language or software code as a component of the prompt, an image 10054 as a component of the prompt, and video 10055 as a component of the prompt. The example of FIG. 1A shows the artificial intelligence response display region 10061 displaying, for example, an icon 10062 indicating the artificial intelligence or the artificial intelligence assistant, text 10063 such as natural language or software code as a component of a response from the artificial intelligence, an image 10064 as a component of a response from the artificial intelligence, and video 10065 as a component of a response from the artificial intelligence. Note that the display example of the display 10011 of the artificial intelligence response output apparatus 10010 shown in FIG. 1A is merely one example. A display that differs from the example shown in FIG. 1A may be displayed depending on an implementation example in which the artificial intelligence response output apparatus 10010 is used.

Here, the large language model will be described. The large language model is also referred to as LLM. Specifically, various models such as GPT-1, GPT-2, GPT-3, InstructGPT, and ChatGPT have been made available. These techniques may also be used in the present embodiment. Note that these large language models are artificial intelligence models generated through large-scale pre-training on natural language contained in numerous documents and texts existing in the human world. The number of parameters in these artificial intelligence models exceeds one billion. Further, there are models that have been enhanced with reinforcement learning based on human feedback. An example of a model based on this includes a model called a transformer. An example of learning of these models can be found in, for example, Reference 1.

### [Reference 1]

Long Ouyang, et. al. “Training language models to follow instructions with human feedback”, https://arxiv.org/pdf/2203.02155.pdf

These large language models are capable of performing natural language translation, natural language proofreading, natural language summarization, and the like. Among these, advanced models are capable of responding in natural language (also called dialogue or conversation), generating suggestions in natural language, generating programming code, and the like. The number of parameters in these artificial intelligence models is extremely large, requiring vast amounts of data and computational resources for training. Therefore, training artificial intelligence at this level for a specific use is extremely inefficient in terms of resources. Thus, as a foundation model that can be applied to various uses, a model has been generated through large-scale pre-training. For example, the large language model server 19001 and/or the multimodal large language model server 20001 shown in FIG. 1A may comprise such a large language model, and may be configured to utilize various terminals via an API (Application Programming Interface). In addition, the artificial intelligence response output apparatus 10010 shown in FIG. 1A may comprise the local large language model, and may be configured to be utilized by the artificial intelligence response output apparatus 10010 itself. Training of these large language models may be performed separately through large-scale pre-training, and the generated large language model may be replicated and loaded in the large language model server 19001, the multimodal large language model server 20001, the artificial intelligence response output apparatus 10010, or the like. In this manner, instead of performing pre-training for each use or terminal, replicating the large language model which is the foundation model generated through large-scale pre-training and utilizing it on individual servers or terminals allows for shared resource consumption during training, resulting in improved efficiency in terms of resources.

Note that even if the large language model as the foundation model generated through large-scale pre-training is used, it may be configured to perform additional training such as transfer learning in individual servers or apparatuses according to the use or purpose.

In addition, the large language model can perform pre-training of natural language and perform input/output processing targeting natural language. Further, the multimodal large language model artificial intelligence capable of processing not only natural language text information but also other types of information other than the natural language text information can also be applied to the embodiment of the present invention. FIG. 1A shows the large language model server 20001 having the multimodal large language model. Examples of the multimodal large language model artificial intelligence specifically include GPT-4 (see Reference 2) and Gato (see Reference 3). These techniques may also be used in the present embodiment. Note that these multimodal large language models are artificial intelligence models generated through large-scale pre-training on natural language contained in numerous documents and texts existing in the human world and types of information other than the natural language text information (such as image, video, audio). Further, there are models that have been enhanced with reinforcement learning based on human feedback. Hereinafter, types of information other than the natural language text information such as image, video, and audio may also be referred to as a non-natural language information source.

### [Reference 2]

Open AI “GPT-4 Technical Report”, https://cdn.openai.com/papers/gpt-4.pdf

### [Reference 3]

Scott Reed, et. al. “A Generalist Agent”, https://arxiv.org/pdf/2205.06175.pdf

Next, a configuration example of the artificial intelligence response output apparatus 10010 configured to receive input from the user for the above-described artificial intelligence such as large language models, and to output the response from the artificial intelligence such as the large language model corresponding to the input from the user will be described with reference to FIG. 1B.

The artificial intelligence response output apparatus 10010 comprises the display 10011, a controller 1110, a memory 1109, a non-volatile memory 1108, an external power supply input interface 1111, an operation input unit 1107, a power supply 1106, a secondary battery 1112, a storage 1170, an image controller 1160, a posture sensor 1113, a position sensor 1114, a local LLM processor 10028, the communication unit 1132, the audio output unit 1140, the microphone 1139, an image signal input unit 1131, an audio signal input unit 1133, an imager 1180, a clock 1196, and the like. The artificial intelligence response output apparatus 10010 may be an apparatus having, for example, a large screen such as a monitor or a television set.

The display 10011 may be a flat panel display, a screen that projects an image from the rear surface, or a component that displays an aerial floating video formed in midair by an optical image. In a case where the display 10011 is a flat panel display, the display may be a liquid crystal display having a liquid crystal panel and a backlight. In addition, the display 10011 may be a plasma display. The display 10011 may be an organic EL display in which pixels emit light. In a case where the display 10011 is a panel, it may also be referred to as a display panel. The display 10011 may be provided with a touch operation input sensor configured to receive a touch operation input by a finger of a user 230. In this case, the display 10011 may be configured as a touch panel. Operation input by the user via the touch panel allows the artificial intelligence response output apparatus 10010 to acquire user input that is the basis of the prompt for the large language model which is artificial intelligence.

The communication unit 1132 may be configured with a Wi-Fi (registered trademark) communication interface, a Bluetooth (registered trademark) communication interface, a mobile communication interface such as 4G or 5G, or the like. These communication methods are used such that the communication unit 1132 of the artificial intelligence response output apparatus 10010 can communicate with the communication apparatus 19011 connected to the Internet 19000. Note that the communication path between the communication unit 1132 and the communication apparatus 19011 may include both wired and wireless portions, and may pass through a router or a repeater. In the case of the wired communication, the communication unit 1132 may have an Ethernet (registered trademark) connection interface as hardware and perform communication using a LAN communication method. In this manner, the artificial intelligence response output apparatus 10010 can communicate with various servers connected to the Internet 19000.

The artificial intelligence response output apparatus 10010 comprises the controller 1110 such as a CPU and the memory 1109, and the controller 1110 controls the display 10011, the communication unit 1132, and the like.

The power supply 1106 converts AC current input from an external component via the external power supply input interface 1111 into DC current and supplies the necessary DC current to each unit of the artificial intelligence response output apparatus 10010. The secondary battery 1112 stores the power supplied from the power supply 1106. In addition, the secondary battery 1112 supplies power to each unit that requires power in a case where power is not supplied from the external component via the external power supply input interface 1111.

The operation input unit 1107 is, for example, an operation button or a signal receiver for a remote controller or the like, or an infrared light receiver, and inputs a signal regarding an operation that differs from the touch operation on the touch operation input sensor of the display 10011 by the user. The operation input unit 1107 may also be used by, for example, an administrator to operate the artificial intelligence response output apparatus 10010, separately from the user who performs the touch operation on the touch operation input sensor of the display 10011. The operation input by the user via the operation input unit 1107 allows the artificial intelligence response output apparatus 10010 to acquire user input that is the basis of the prompt for the large language model which is artificial intelligence. Note that there may also be a modification configured such that the touch operation input sensor of the display 10011 is included as a portion of the operation input unit 1107.

The image signal input unit 1131 connects to an external image output apparatus to input image data. The image signal input unit 1131 may be configured with various digital image input interfaces. For example, it may be configured with an HDMI (registered trademark) (High-Definition Multimedia Interface) compliant image input interface, a DVI (Digital Visual Interface) compliant image input interface, a DisplayPort compliant image input interface, or the like. Alternatively, an analog image input interface such as an analog RGB or a composite video may be provided. The image signal input unit 1131 may also be various USB interfaces and the like.

The audio signal input unit 1133 connects to an external audio output apparatus to input audio data. The audio signal input unit 1133 may be configured with an HDMI compliant audio input interface, an optical digital terminal interface, a coaxial digital terminal interface, or the like. The audio signal input unit 1133 may also be various USB interfaces and the like. In the case of the HDMI compliant interface, the image signal input unit 1131 and the audio signal input unit 1133 may be configured as an interface with an integrated terminal and cable.

The audio output unit 1140 can output audio based on audio data input to the audio signal input unit 1133. The audio output unit 1140 can also output audio based on audio data stored in the storage 1170. The audio output unit 1140 may be configured with a speaker. In addition, the audio output unit 1140 may output a built-in operation sound or an error warning sound. Alternatively, the audio output unit 1140 may be configured to output an audio signal as a digital signal to an external device in accordance with an audio return channel function defined in the HDMI standard. Alternatively, the audio output unit 1140 may be configured to output an audio signal as an analog signal to an external device such as a headphone.

The microphone 1139 captures sound surrounding the artificial intelligence response output apparatus 10010 and converts it into a signal to generate an audio signal. The microphone may record human voices such as the user's voice, and the controller 1110 described below may perform audio recognition processing on the generated audio signal to acquire text information from the audio signal. Audio input from the microphone 1139 allows the artificial intelligence response output apparatus 10010 to acquire user input that is the basis of the prompt for the large language model which is artificial intelligence.

The imager 1180 is a camera having an image sensor. The camera may be provided on a front surface side or a rear surface side of the display 10011 of the artificial intelligence response output apparatus 10010. Cameras may be provided on both the front surface and the rear surface. In the present embodiment, the imager 1180 is described as having cameras on both the front surface and the rear surface.

The storage 1170 is a storage apparatus that records various types of information of various types of data such as video data, image data, and audio data. The storage 1170 may be configured with a magnetic recording media apparatus such as a hard disk drive (HDD) or a semiconductor device memory such as a solid-state drive (SSD). For example, the storage 1170 may record information of various types of data such as video data, image data, and audio data prior to product shipment. In addition, the storage 1170 may record information of various types of data such as video data, image data, and audio data acquired from an external device, an external server, or the like via the communication unit 1132. Video data, image data, and the like recorded in the storage 1170 is output to the display 10011. Video data, image data, and the like recorded in the storage 1170 may be output to an external device, an external server, or the like via the communication unit 1132.

The image controller 1160 performs various controls regarding image signals input to the display 10011. The image controller 1160 may also be referred to as an image processing circuit, and may be configured with, for example, hardware such as an ASIC, an FPGA, or an image processor. Note that the image controller 1160 may also be referred to as a video processor or an image processor. The image controller 1160 performs image switching controls such as determining which image signal to input to the display 10011 from among the image signals stored in the memory 1109 and the image signals (image data) input to the image signal input unit 1131. In addition, the image controller 1160 may perform image processing controls on the image signal input from the image signal input unit 1131, the image signal stored in the memory 1109, and the like. Image processing includes, for example, scaling processing such as enlarging, reducing, or transforming the image, brightness adjustment processing for changing brightness of the image, contrast adjustment processing for changing the contrast curve of the image, and retinex processing such as decomposing the image into a light component and changing the weighting of each component.

The posture sensor 1113 is constituted by a gravity sensor or an acceleration sensor or a combination thereof, and can detect a posture of the artificial intelligence response output apparatus 10010. The controller 1110 may control the operation of each connected unit based on a posture detection result of the posture sensor 1113.

The position sensor 1114 measures the position of the artificial intelligence response output apparatus 10010 using GNSS (Global Navigation Satellite System) such as GPS (Global Positioning System). Note that, in a case where the position of the artificial intelligence response output apparatus 10010 can be estimated based on the information acquired via communication with the communication unit 1132, the position estimated by this method may be substituted for a measurement result of the position sensor 1114. Note that the position sensor 1114 may receive UTC (Coordinated Universal Time) time information transmitted by the GNSS.

The non-volatile memory 1108 stores various types of data used for the artificial intelligence response output apparatus 10010. The data stored in the non-volatile memory 1108 includes, for example, data for various operations displayed on the display 10011 of the artificial intelligence response output apparatus 10010, a display icon, data for an object operated by the user for operation, layout information, and the like. The memory 1109 stores the image data to be displayed on the display 10011, data for controlling the apparatus, and the like. The controller 1110 may read various software from the storage 1170, and load and store it in the memory 1109.

The local LLM processor 10028 comprises a memory capable of holding the large language model (LLM), and can execute inference of the large language model based on the control of the controller 1110. The hardware may be configured with the so-called GPU (Graphics Processing Unit) or the like. Another example of the hardware for the local LLM processor 10028 may be configured with the so-called NPU (Neural network Processing Unit). The local LLM processor 10028 may perform not only inference but also training. Note that, in a case where execution of inference of the large language model in a local environment of the artificial intelligence response output apparatus 10010 and the like is not required, the local LLM processor 10028 is not necessary.

The controller 1110 controls the operation of each connected unit. In addition, the controller 1110 may cooperate with a program stored in the memory 1109 and perform arithmetic processing based on information acquired from each unit in the artificial intelligence response output apparatus 10010. A control state of the controller 1110 includes, for example, a state in which the response from the large language model of the local LLM processor 10028 or the response from the large language model of the large language model server 19001 or the multimodal large language model of the multimodal large language model server 20001 acquired via the communication unit 1132 is output via the display 10011 or the audio output unit 1140 such as the speaker. A specific configuration of the controller 1110 includes components such as a CPU, and may also be referred to as a processor or a control circuit.

The clock 1196 counts the time or time intervals used for controlling the controller 1110 of the artificial intelligence response output apparatus 10010. The clock 1196 may function as an internal clock that increments a counter value. Alternatively, the clock 1196 may count the time using UTC (Coordinated Universal Time) which is a globally standardized time, or regional times such as JST (Japan Standard Time). The clock 1196 may autonomously count the time as an internal clock. Alternatively, the clock may calibrate the time using external information at a predetermined timing. For example, in a case where the clock 1196 counts the UTC time, the clock 1196 may acquire time information such as NTP (Network Time Protocol) information regarding UTC from an NTP server or an external device via the communication unit 1132, and may calibrate the time using the acquired NTP information. In addition, the clock 1196 may acquire UTC time information received by the position sensor 1114 from the GNSS, and may calibrate the time using the acquired UTC time information. For example, in a case where the clock 1196 counts the regional time such as JST, the clock 1196 may acquire regional time information such as TOT (Time Offset Table) from a server or an external device via the communication unit 1132, and may calibrate the time using the acquired regional time information. In addition, the clock 1196 may acquire UTC time information and position information received by the position sensor 1114 from the GNSS, including latitude and longitude information where the artificial intelligence response output apparatus 10010 is located. The clock may then calculate the time information for the region where the artificial intelligence response output apparatus 10010 is located using the acquired UTC time information and the position information, and may calibrate the time using the calculated result.

Note that, in a case where input is received from the user via the above-described touch panel, the microphone 1139, or the operation input unit 1107, the controller 1110 may perform controls to generate a prompt based on the input, send the prompt to the local large language model of the local LLM processor 10028, the large language model of the large language model server 19001, or the multimodal large language model of the large language model server 20001 of the artificial intelligence response output apparatus 10010, and acquire responses from these large language models.

Note that, in the example of FIGS. 1A and 1B, the artificial intelligence response output apparatus 10010 is shown as comprising the display 10011. However, the artificial intelligence response output apparatus 10010 according to the embodiments of the present invention does not necessarily need to comprise the display 10011. For example, even without the display 10011, the apparatus may be configured to receive input from the user input to the artificial intelligence via the audio signal input unit 1133 or the microphone 1139, and to output the response corresponding to the user input from the artificial intelligence such as the large language model via the audio output unit 1140.

According to the artificial intelligence response output apparatus and artificial intelligence response output system according to the above-described first embodiment of the present invention, it is possible to receive input from the user to the artificial intelligence such as the large language model, and to output a response corresponding to the input from the user and generated by inference of the artificial intelligence such as a large language model of a server apparatus on a network or the local large language model of the artificial intelligence response output apparatus itself.

Note that the artificial intelligence response output apparatus 10010 according to the embodiments of the present invention can be implemented as various forms of devices. FIG. 1C shows such an example. For example, the artificial intelligence response output apparatus 10010 may be a display apparatus 181 such as a television set, a monitor, or a display apparatus as shown in (1) of FIG. 1C. The display apparatus 181 displays an image on a display screen such as a display panel. The artificial intelligence response output apparatus 10010 may also be an information processing terminal 182 such as a smartphone, a tablet terminal, or a PC (personal computer) as shown in (2) of FIG. 1C. The information processing terminal 182 displays an image on a display screen such as a display panel. The artificial intelligence response output apparatus 10010 may also be a head-mounted display (HMD) 183 as shown in (3) of FIG. 1C. In this case, the artificial intelligence response output apparatus 10010 comprises an eyepiece optical system that projects the image displayed on the display 10011 onto the user's eye and generates a virtual image displaying the image. The artificial intelligence response output apparatus 10010 may also be a head-up display (HUD) 184 as shown in (4) of FIG. 1C. The head-up display 184 generates a virtual image 192 by reflecting projected light off a transparent member 191 such as glass and displays an image on the virtual image. In this case, the artificial intelligence response output apparatus 10010 comprises an optical system for projecting light emitted from the display 10011 onto the transparent member 191. The artificial intelligence response output apparatus 10010 may also be an aerial floating video display apparatus 185 as shown in (5) of FIG. 1C. The aerial floating video display apparatus 185 reflects light emitted from a display apparatus 193 using an imaging optical plate 194 such as a retroreflector or a corner reflector array to generate a real optical image 195 in midair and display an image on the optical image. The artificial intelligence response output apparatus 10010 may be a projection-type image display apparatus 186 such as a projector that projects an image 196 onto a screen or a wall as shown in (6) of FIG. 1C. In this case, the artificial intelligence response output apparatus 10010 comprises a display panel as the display 10011, a light source, an illumination optical system that guides light from the light source to the display 10011, and a projection optical system that projects the light from the light source and transmitted or reflected by the display panel onto a screen or a wall.

Next, an example of a configuration of the large language model server 20001 according to the embodiment of the present invention will be described with reference to FIG. 1D. Note that, although this figure shows one exemplary configuration of the large language model server 20001, the large language model server 19001 and the second server 19002 may also have similar configurations.

The large language model server 20001 may comprise, for example, a user interface 22010, an input interface 22011, an output interface 22012, an external power supply input interface 22014, a power supply 22015, a storage 22020, various databases (DB) 22021, a training data database (DB) 22022, a controller 22030, a memory 22031, a non-volatile memory 22032, a communication unit 22035, an AI computation unit 22040, an LLM processor 22041, various AI processors 22042, a cooler 22050, and the like.

Specifically, the user interface 22010 is an interface that allows a user of the server such as an administrator or maintenance personnel of the large language model server 20001 to operate the server. The user interface 22010 comprises, for example, the input interface 22011. The input interface 22011 is an interface that allows the user to input an operation input or control information for operating or controlling the server. For example, the input interface 22011 may be a physical operation button, an operation input panel such as a touch panel, or a remote controller. Alternatively or additionally, the user interface may comprise an interface that connects with the user's information terminal to allow control information to be input from the information terminal. Specifically, the user interface may comprise a communication interface such as a USB interface using a Universal Serial Bus or an Ethernet interface. In addition, the user interface 22010 comprises the output interface 22012. The output interface 22012 is an interface for outputting information and the like from the server to the user such as the administrator. For example, the output information may include operation status such as server load, presence of errors, or information on an error type when an error is present. In addition, the output information may include information regarding the AI computation unit 22040. The information regarding the AI computation unit 22040 may include information on the type of large language model being used to execute inference of the LLM processor 22041, or information regarding execution status of the inference such as progress rate. For example, the output interface 22012 may comprise an interface for connecting the user's information terminal to allow information to be output to the information terminal. Specifically, the output interface may be a communication interface such as a USB interface or an Ethernet interface. Alternatively or additionally, a display may be provided as the output interface 22012. This allows information to be communicated to the user via a display image or a display video. Note that, in a case where the user interface 22010 is a communication interface, hardware may be shared with the communication unit 22035 described below.

The power supply 22015 converts AC current input from an external component via the external power supply input interface 22014 into DC current and supplies the necessary DC current to each unit of the large language model server 20001.

The storage 22020 is a storage apparatus that records various types of information of various types of data such as image data, video data, audio data, text data, and the like. The information may be stored in a database (DB) structure. The storage 22020 may be configured with a magnetic recording media apparatus such as a hard disk drive (HDD) or a semiconductor device memory such as a solid-state drive (SSD). The illustrated example shows the storage 22020 configured within the large language model server 20001. However, the storage 22020 may be placed outside the large language model server 20001 and be configured to connect to the large language model server 20001 via a communication interface. In the illustrated example, the storage 22020 includes the various databases 22021. The information stored in the various databases 22021 may, for example, be output to the AI computation unit 22040 described below. In this case, the AI computation unit 22040 can use the information stored in the various databases 22021 for inference. In addition, the storage 22020 may record pieces of data such as image data, video data, audio data, and text data which are results of inference of the AI computation unit 22040 into the various databases 22021. In addition, the information stored in the various databases 22021 may, for example, be output as a response to accessing from the communication unit 22035 described below and an external device connected via the Internet 19000. In addition, the storage 22020 may record pieces of data such as image data, video data, audio data, and text data transmitted from the communication unit 22035 and the external device connected via the Internet 19000 into the various databases 22021.

In addition, in a case where training is performed on the AI model such as the large language model used in the AI computation unit 22040 described below for the large language model server 20001, the storage 22020 may store the training data database 22022 that includes training data such as image data, video data, audio data, and text data serving as target data for the training.

The controller 22030 controls the operation of each unit in the large language model server 20001. In addition, the controller 22030 may cooperate with a program stored in the memory 22031 and perform arithmetic processing based on information acquired from each unit in the large language model server 20001. A control state of the controller 22030 includes, for example, a state in which the various types of control information and prompt are received from an external device via the communication unit 22035 and the Internet 19000, and a state in which inference of the large language model is executed on the AI computation unit 22040 using the various types of control information and prompt. In addition, the control state of the controller 22030 includes, for example, a state in which the output from the large language model of the AI computation unit 22040 described below is output to an external device via the communication unit 22035 and the Internet 19000. A specific configuration of the controller 22030 includes components such as a CPU, and may also be referred to as a processor or a control circuit.

The non-volatile memory 22032 stores various types of data used for the large language model server 20001. The data stored in the non-volatile memory 22032 includes, for example, various types of data output from the output interface 22012 of the large language model server 20001.

The memory 22031 stores control data and the like to be used by the controller 22030. The controller 22030 may read various software/applications from the storage 22020 and load and store it in the memory 22031.

The communication unit 22035 is a communication interface such as an Ethernet interface and is connected to the Internet 19000 via a router, a switch, a gateway apparatus, or the like. Note that the communication path between the communication unit 22035 and the Internet 19000 may include wired and wireless portions, and may pass through a repeater or the like. In a case where the communication unit 22035 is an Ethernet interface, communication may be performed using a LAN communication method up to the predetermined router, the switch, or the gateway apparatus. In this manner, the communication unit 22035 can communicate with apparatuses such as the communication unit 1132 of the artificial intelligence response output apparatus 10010 and other servers via the Internet 19000. The communication unit 22035 can communicate with the communication unit 1132 of the artificial intelligence response output apparatus 10010, and can transmit and receive prompt, control information, and an artificial intelligence response between the AI computation unit 22040 described below and the artificial intelligence response output apparatus 10010 using the API.

The AI computation unit 22040 executes inference of the AI model such as a neural network. Specifically, the AI computation unit is a processor or circuit such as a GPU (Graphics Processing Unit). The AI computation unit may be configured with a plurality of cores with the GPU and GPU memory as the core. Another example of hardware for the AI computation unit 22040 may be configured with the so-called NPU (Neural network Processing Unit). The AI model that executes inference in the AI computation unit 22040 includes, for example, various deep learning neural networks. Specifically, the AI model may be an LLM (large language model). Alternatively, the AI model may be an image recognition processing model or an audio recognition processing model. The model configuration may be a CNN (Convolutional Neural Network), an RNN (Recurrent Neural Network), a transformer, an autoencoder, a GAN (Generative Adversarial Network), or a diffusion model.

In the example of FIG. 1D, the AI computation unit 22040 comprises an LLM AI model and the LLM processor 22041 that executes inference of the LLM. For example, the LLM to which the LLM processor 22041 executes inference is at least an AI model trained on text information. In addition, the LLM to which the LLM processor 22041 executes inference may be a multimodal LLM trained not only on text data but also on media other than text data. Such media other than text data includes, for example, image data, video data, audio data, or the like. The LLM processor 22041 performs communication via the communication unit 22035 using the API to acquire prompt or control information from an external device such as the artificial intelligence response output apparatus 10010 connected to the Internet 19000, and executes inference of the LLM based on the information. The execution result of the inference is output to the external device as the artificial intelligence response by communication via the communication unit 22035 using the API. This series of processing may be controlled by, for example, the controller 22030.

In addition, the AI computation unit 22040 may comprise various AI models other than the LLM, and may comprise the various AI processors 22042 that execute inference of the various AI models. Examples of the various AI models other than the LLM may include a clustering AI model trained using unsupervised learning, a regression prediction AI model trained using supervised learning, or a classification AI model trained using supervised learning. The various AI processors 22042 performs communication via the communication unit 22035 using the API to acquire control information from an external device such as the artificial intelligence response output apparatus 10010 connected to the Internet 19000, and executes inference of the various AI models based on the information. The execution result of the inference is output to the external device as the artificial intelligence response by communication via the communication unit 22035 using the API. This series of processing may be controlled by, for example, the controller 22030.

Note that, in a case where training is performed on the AI model such as the large language model of the large language model server 20001, the AI computation unit 22040 may perform training on the AI model using image data, video data, audio data, text data, and the like stored in the training data database 22022 of the storage 22020 as training data.

The cooler 22050 is mainly configured to cool the AI computation unit 22040. Training and inference of the AI model require significant power and generate heat. Therefore, a configuration is necessary to forcibly cool the AI computation unit 22040. Specifically, the cooler 22050 may be an air-cooling forced convection apparatus such as a fan, or may be a liquid-cooling forced convection apparatus such as a pump. Alternatively, the cooler 22050 may be a heat exchanger such as a heat pipe.

According to the server configuration described with reference to FIG. 1D, the AI computation unit 22040 can execute inference of the AI model based on control information received by communication via the communication unit 22035 and output the result as the artificial intelligence response by communication via the communication unit 22035.

Note that the server in FIG. 1D has been described as a single physical server as an example. However, the server may also be a virtualized server utilizing a plurality of physical servers. The server may also be configured as a cloud server in which various functions are distributed and virtualized on a cloud (cloud computing system).

In addition, the controller 22030 may monitor the operation status such as power consumption of the power supply 22015, the load on the AI computation unit 22040, and the load on the forced convection apparatus such as the fan or pump of the cooler 22050. Information of these operation statuses monitored by the controller 22030 may be output to the output interface 22012 such as the user interface 22010. In addition, information of these operation statuses monitored by the controller 22030 may be output to a network such as the Internet 19000 via the communication unit 22035. The information of the output operation status may be configured to be acquired by an external device such as the artificial intelligence response output apparatus 10010 connected to the network.

Next, an example of loading and executing a client application and an LLM application in the artificial intelligence response output system will be described with reference to FIG. 1E. The example of FIG. 1E is a schematic diagram focusing on loading, execution, and communication of the client application and LLM application in the configuration of the artificial intelligence response output system including the artificial intelligence response output apparatus 10010 and the large language model server 20001. For simplicity, configurations other than those of the client application and the LLM application are omitted from the drawings and description.

In the example of FIG. 1E, a client application 8010 is executed in the artificial intelligence response output apparatus 10010. Specifically, the client application 8010 is loaded in the memory 1109 shown in FIG. 1B and executed by the controller 1110. In addition, a server LLM application 8020 is executed in the large language model server 20001. Specifically, the server LLM application 8020 is loaded in the memory 22031 shown in FIG. 1D and executed by the controller 22030. The server LLM application 8020 may control the entire large language model of the large language model server 20001. The server LLM application 8020 performs, for example, a control to execute inference of the LLM AI model of the LLM processor 22041 of the AI computation unit 22040 shown in FIG. 1D. In addition, the server LLM application 8020 may control input and output of information with respect to the large language model of the large language model server 20001. The client application 8010 and the server LLM application 8020 communicate via, for example, the communication unit 1132 shown in FIG. 1B, the communication apparatus 19011 shown in FIG. 1A, a network such as the Internet 19000, and the communication unit 22035 shown in FIG. 1D. For example, the prompt from the client application 8010 is sent to the server LLM application 8020. The server LLM application 8020 that received the prompt performs a control to execute inference of the LLM AI model of the LLM processor 22041 of the AI computation unit 22040 shown in FIG. 1D. The artificial intelligence response which is the result of the inference is sent to the client application 8010 by the server LLM application 8020. The client application 8010 can output an output based on the artificial intelligence response to the user. In this manner, in the artificial intelligence response output system of the example of FIG. 1E, the client application 8010 and the server LLM application 8020 cooperate to output a more suitable artificial intelligence response to the user. Here, the large language model of the large language model server 20001 may also be referred to as a server large language model. The server LLM application 8020 may also be referred to as a server large language model application.

In addition, in the example of FIG. 1E, a local LLM application 8015 is executed in the artificial intelligence response output apparatus 10010. Specifically, in the artificial intelligence response output apparatus 10010, the local LLM application 8015 is loaded in the memory 1109 shown in FIG. 1B and executed by the controller 1110. The local LLM application 8015 may control the entire large language model of the local LLM processor 10028 shown in FIG. 1B. The local LLM application 8015 performs, for example, a control to execute inference of the large language model of the local LLM processor 10028 shown in FIG. 1B. In addition, the local LLM application 8015 may control input and output of information with respect to the large language model of the local LLM processor 10028. The client application 8010 and the local LLM application 8015 communicate via, for example, a communication path such as a bus in the artificial intelligence response output apparatus 10010. For example, the prompt from the client application 8010 is sent to the local LLM application 8015. The local LLM application 8015 that received the prompt performs a control to execute inference of the large language model of the local LLM processor 10028 shown in FIG. 1B. The artificial intelligence response which is the result of the inference is sent to the client application 8010 by the local LLM application 8015. The client application 8010 can output an output based on the artificial intelligence response to the user. In this manner, in the artificial intelligence response output system of the example of FIG. 1E, the client application 8010 and the local LLM application 8015 cooperate to output a more suitable artificial intelligence response to the user. Here, the large language model of the local LLM processor 10028 may also be referred to as a local large language model. The local LLM application 8015 may also be referred to as a local large language model application.

In addition, in the artificial intelligence response output system of the example of FIG. 1E, the client application 8010, the local LLM application 8015, and the server LLM application 8020 can cooperate to output a more suitable artificial intelligence response to the user.

Note that, in the example of FIGS. 1A, 1D, and 1E, the artificial intelligence response output apparatus 10010 and the large language model server 20001 are connected via the Internet 19000. That is, the server LLM application 8020 of FIG. 1E is connected to the client application 8010 via the Internet 19000. However, the network connecting the artificial intelligence response output apparatus 10010 and the large language model server 20001 is not limited to the Internet 19000, and may be the so-called LAN (Local Area Network). The network connecting the artificial intelligence response output apparatus 10010 and the large language model server 20001 may be the so-called local 5G network. In these cases, the artificial intelligence response output apparatus 10010 having the client application 8010 and the local LLM application 8015 may be in the same subnet mask as the server LLM application 8020 and the large language model server 20001. In this manner, the artificial intelligence response system including the artificial intelligence response output apparatus 10010 and the large language model server 20001 and constructed without utilizing the Internet 19000 can be used within local areas such as at home, at a factory, or at a hospital. In this case, if communication with the Internet 19000 is interrupted for any reason, the client application 8010 of the artificial intelligence response output apparatus 10010 can communicate and cooperate with the server LLM application 8020 of the large language model server 20001 via the LAN or local 5G network.

### Second Embodiment

Next, an example in which the artificial intelligence response output apparatus 10010 according to the first embodiment is connected to the Internet and operates by connecting to a server having the large language model artificial intelligence via the Internet will be described as a second embodiment of the present invention. In the present embodiment, only differences from the first embodiment will be described, and descriptions of configurations similar to those of the first embodiment will be omitted as appropriate.

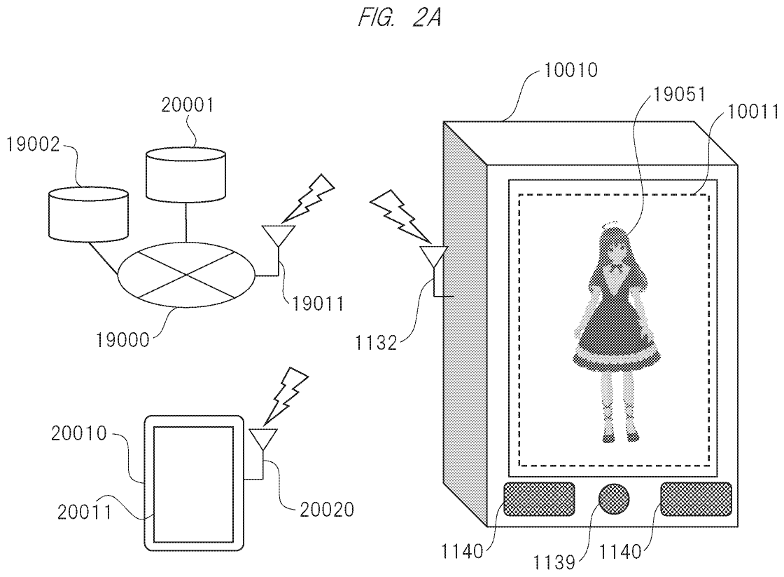

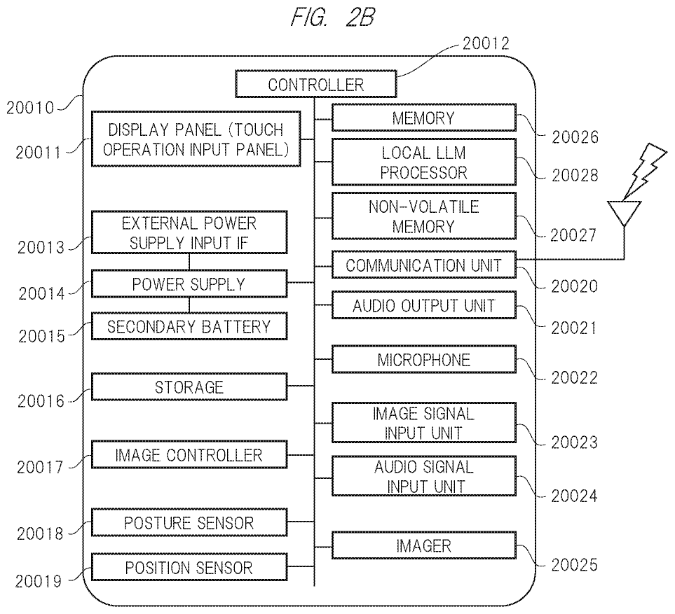

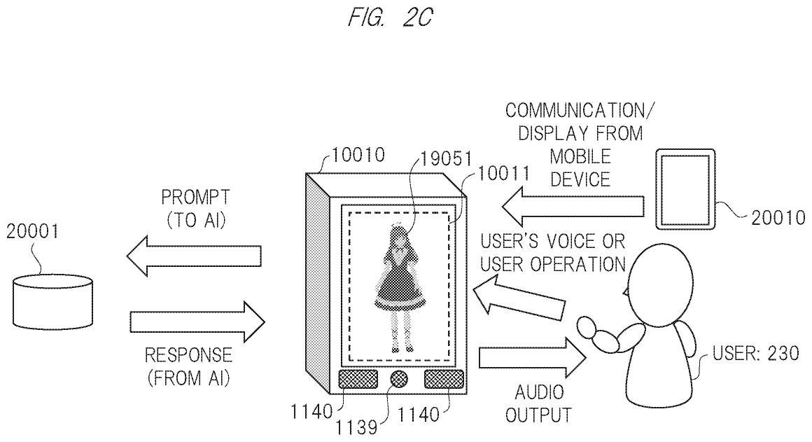

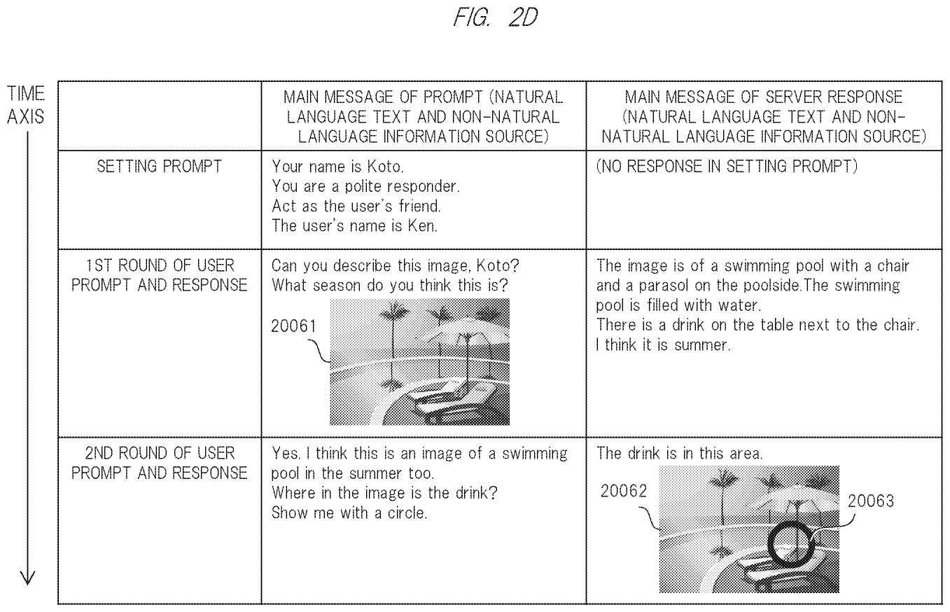

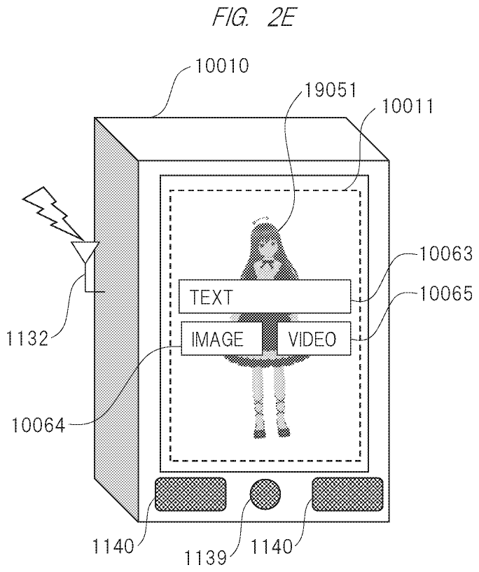

An example of a connection state between the artificial intelligence response output apparatus 10010 and the large language model server 20001 according to the second embodiment of the present invention will be described with reference to FIG. 2A. The artificial intelligence response output apparatus 10010 according to the second embodiment has a function to display a character or an avatar, and may also be referred to as a character conversation apparatus or an avatar display apparatus. In addition, a system including the artificial intelligence response output apparatus 10010 and the large language model server 20001 according to the second embodiment may also be referred to as a character conversation system or an avatar conversation system. The display 10011 displayed by the artificial intelligence response output apparatus 10010 displays an image of a character 19051. The image of the character 19051 is generated by rendering a 3D model of a character in a virtual space. Since repeatedly stating “character or avatar” is redundant, the term “character” will be used throughout the remainder of the present embodiment.

In addition, the character in the present embodiment provides the user with a service of the large language model which is artificial intelligence to assist the user. Therefore, the character can serve as an artificial intelligence (AI) assistant for the user. In this case, the character conversation apparatus or the character conversation system in the present embodiment may also be referred to as an AI assistant conversation apparatus, an AI assistant display apparatus, an AI assistant response output apparatus, an AI assistant conversation system, an AI assistant display system, or an AI assistant response output system.

In the example of FIG. 2A, the audio output unit 1140 of the artificial intelligence response output apparatus 10010 is configured with a speaker. In addition, the artificial intelligence response output apparatus 10010 comprises the microphone 1139 and can capture the user's voice. The artificial intelligence response output apparatus 10010 can communicate with the communication apparatus 19011 connected to the Internet 19000 via the communication unit 1132. The example of FIG. 2A shows wireless communication between the communication unit 1132 and the communication apparatus 19011. However, the communication may be a wired communication. The communication path between the communication unit 1132 and the Internet 19000 may include both wired and wireless portions. The artificial intelligence response output apparatus 10010 can communicate with the large language model server 20001 via the communication apparatus 19011 and the Internet 19000. In addition, the artificial intelligence response output apparatus 10010 can communicate with the second server 19002 that differs from the large language model server 20001 via the communication apparatus 19011 and the Internet 19000. A configuration including the artificial intelligence response output apparatus 10010 and the large language model server 20001 may be considered as a single system.

Here, the large language model server 20001 is equipped with the large language model artificial intelligence. For example, the large language model server 20001 has a multimodal large language model capable of processing both natural language text information and other types of information.

The artificial intelligence response output apparatus 10010 can communicate with the large language model of the large language model server 20001 via the Internet 19000 using the API.

The artificial intelligence response output system of the second embodiment includes a mobile information processing terminal 20010 to be used by the user 230. The mobile information processing terminal 20010 is the so-called smartphone or tablet information processing terminal.

Here, an example of the mobile information processing terminal 20010 will be described with reference to FIG. 2B. The mobile information processing terminal 20010 comprises a display panel 20011 which is a touch operation input panel, a controller 20012, a memory 20026, a non-volatile memory 20027, an external power supply input interface 20013, a power supply 20014, a secondary battery 20015, a storage 20016, an image controller 20017, a posture sensor 20018, a position sensor 20019, a local LLM processor 20028, a communication unit 20020, an audio output unit 20021, a microphone 20022, an image signal input unit 20023, an audio signal input unit 20024, an imager 20025, and the like.

The display panel 20011 comprises the touch operation input sensor, and can receive the touch operation input by a finger of the user 230. The display panel 20011 performs displaying with a liquid crystal panel or an organic EL panel, and can display an image. The display panel 20011 may also be referred to as a display.

The communication unit 20020 may be configured with a Wi-Fi communication interface, a Bluetooth communication interface, a mobile communication interface such as 4G or 5G, or the like. These communication methods are used such that the communication unit 20020 of the mobile information processing terminal 20010 can communicate with the communication unit 1132 of the artificial intelligence response output apparatus 10010. The controller 20012 may control the communication unit 20020. In addition, the communication unit 20020 can communicate with the communication apparatus 19011 connected to the Internet 19000 by using any of the communication methods of the communication unit 20020. In this manner, the mobile information processing terminal 20010 can communicate with various servers connected to the Internet 19000.

The power supply 20014 converts AC current input from an external component via the external power supply input interface 20013 into DC current and supplies the necessary DC current to each unit of the mobile information processing terminal 20010. The secondary battery 20015 stores the power supplied from the power supply 20014. In addition, the secondary battery 20015 supplies power to each unit that requires power in a case where power is not supplied from the external component via the external power supply input interface 20013.

The image signal input unit 20023 connects to an external image output apparatus to input image data. The image signal input unit 20023 may be configured with various digital image input interfaces. For example, it may be configured with an HDMI (registered trademark) (High-Definition Multimedia Interface) compliant image input interface, a DVI (Digital Visual Interface) compliant image input interface, a DisplayPort compliant image input interface, or the like. Alternatively, an analog image input interface such as an analog RGB or a composite video may be provided. The image signal input unit 20023 may also be various USB interfaces and the like.

The audio signal input unit 20024 connects to an external audio output apparatus to input audio data. The audio signal input unit 20024 may be configured with an HDMI compliant audio input interface, an optical digital terminal interface, a coaxial digital terminal interface, or the like. The audio signal input unit 20024 may also be various USB interfaces and the like. In the case of the HDMI compliant interface, the image signal input unit 20023 and the audio signal input unit 20024 may be configured as an interface with an integrated terminal and cable.

The audio output unit 20021 can output audio based on audio data input to the audio signal input unit 20024. The audio output unit 20021 can also output audio based on audio data stored in the storage 20016. The audio output unit 20021 may be configured with a speaker. In addition, the audio output unit 20021 may output a built-in operation sound or an error warning sound. Alternatively, the audio output unit 20021 may be configured to output an audio signal as a digital signal to an external device in accordance with an audio return channel function defined in the HDMI standard.

The microphone 20022 captures sound surrounding the mobile information processing terminal 20010 and converts it into a signal to generate an audio signal. The microphone may record human voice such as the user's voice, and the controller 20012 described below may perform audio recognition processing on the generated audio signal to acquire text information from the audio signal.

The imager 20025 is a camera having an image sensor. The camera may be provided on a front surface side or a rear surface side of the display panel 20011 of the mobile information processing terminal 20010. Cameras may be provided on both the front surface and the rear surface. In the present embodiment, the imager 20025 is described as having cameras on both the front surface and the rear surface.

The storage 20016 is a storage apparatus that records various types of information of various types of data such as video data, image data, and audio data. The storage 20016 may be configured with a magnetic recording media apparatus such as a hard disk drive (HDD) or a semiconductor device memory such as a solid-state drive (SSD). For example, the storage 20016 may record various types of information of various types of data such as video data, image data, and audio data prior to product shipment. In addition, the storage 20016 may record information of various types of data such as video data, image data, and audio data acquired from an external device, an external server, or the like via the communication unit 20020. Video data, image data, and the like recorded in the storage 20016 is output to the display panel 20011. Video data, image data, and the like recorded in the storage 20016 may be output to an external device, an external server, or the like via the communication unit 20020.

The image controller 20017 performs various controls regarding image signals input to the display panel 20011. The image controller 20017 may also be referred to as an image processing circuit, and may be configured with, for example, hardware such as an ASIC, an FPGA, or an image processor. Note that the image controller 20017 may also be referred to as a video processor or an image processor. The image controller 20017 performs image switching controls such as determining which image signal to input to the display panel 20011 from among the image signals stored in a memory 20026 and the image signals (image data) input to the image signal input unit 20023. In addition, the image controller 20017 may perform image processing controls on the image signal input from the image signal input unit 20023, the image signal stored in the memory 20026, and the like. Image processing includes, for example, scaling processing such as enlarging, reducing, or transforming the image, brightness adjustment processing for changing brightness of the image, contrast adjustment processing for changing the contrast curve of the image, and retinex processing such as decomposing the image into a light component and changing the weighting of each component.

The posture sensor 20018 is constituted by a gravity sensor or an acceleration sensor or a combination thereof, and can detect a posture of the mobile information processing terminal 20010. The controller 20012 may control the operation of each connected unit based on a posture detection result of the posture sensor 20018.

The position sensor 20019 measures the position of the mobile information processing terminal 20010 using GPS (Global Positioning System) or the like. Note that, in a case where the position of the mobile information processing terminal 20010 can be estimated based on the information acquired via communication with the communication unit 20020, the position estimated by this method may be substituted for a measurement result of the position sensor 20019.

A non-volatile memory 20027 stores various types of data used for the mobile information processing terminal 20010. The data stored in the non-volatile memory 20027 includes, for example, data for various operations displayed on the display panel 20011 of the mobile information processing terminal 20010, a display icon, data for an object operated by the user for operation, layout information, and the like. The memory 20026 stores the image data to be displayed on the display panel 20011, data for controlling the apparatus, and the like. The controller 20012 may read various software from the storage 20016 and load and store it in the memory 20026.

The local LLM processor 20028 comprises a memory capable of holding the large language model (LLM), and can execute inference of the large language model based on the control of the controller 20012. The hardware may be configured with the so-called GPU (Graphics Processing Unit) or the like. The local LLM processor 20028 may perform not only inference but also training. Note that, in a case where execution of inference of the large language model in a local environment of the mobile information processing terminal 20010 and the like is not required, the local LLM processor 20028 is not necessary.

The controller 20012 controls the operation of each connected unit. In addition, the controller 20012 may cooperate with a program stored in the memory 20026 and perform arithmetic processing based on information acquired from each unit in the mobile information processing terminal 20010. A specific configuration of the controller 20012 includes components such as a CPU, and may also be referred to as a processor or a control circuit.

Next, an example of the operation of the artificial intelligence response output apparatus 10010 according to the second embodiment of the present invention will be described with reference to FIG. 2C. This is also a description of an example of the operation of the artificial intelligence response output system including the artificial intelligence response output apparatus 10010 and the large language model server 20001. Note that the communication paths such as the Internet 19000 shown in FIG. 2A are omitted in FIG. 2C. In FIG. 2C, the user 230 of the artificial intelligence response output apparatus 10010 is also shown. Note that the operation or processing in each unit of the artificial intelligence response output apparatus 10010 according to the second embodiment of the present invention may be controlled by the client application 8010 as described with reference to FIG. 1E. Note that the operation or processing in the large language model server 20001 described in the second embodiment of the present invention may be controlled by the server LLM application 8020 as described with reference to FIG. 1E.

Here, a flow example of a series of operations (first operation example) of the artificial intelligence response output apparatus 10010 will be described. Note that the artificial intelligence response output apparatus 10010 loads a character operation program stored in the storage 1170 or the like to the memory 1109, and the controller 1110 executes the character operation program such that it is possible to achieve various types of processing described below. Note that the character operation program may be the same as that of the above-described client application 8010, or may be a different program. In addition, the character operation program may be a part of a program configuring the above-described client application 8010.

### First Operation Example

First, the artificial intelligence response output apparatus 10010 comprises the microphone 1139. When the user 230 speaks to the character 19051, the user's voice (words spoken by the user) is captured by the microphone 1139 and is converted into an audio signal. Here, the character operation program executed by the controller 1110 extracts the text of the words spoken by the user 230 from the audio signal. The text is natural language. Note that the extraction of the text of the words spoken by the user 230 may be continued for all words, or may be started after a trigger keyword is input and when words are spoken by the user within a predetermined period. For example, the trigger keyword may be a case where the user says “Hello” followed with the character's name. For example, if the name of the character 19051 is “Koto”, the trigger keyword may be “Hello, Koto!”.

Based on the text of the words spoken by the user 230, the character operation program of the artificial intelligence response output apparatus 10010 creates the prompt and sends the prompt to the large language model server 20001 using the API. Here, the prompt may be metadata in which information such as format such as markup format using tags in a markup language, format using a predetermined symbol such as markdown format, or object format using a predetermined script such as JSON is stored. Natural language text information is stored in the prompt as the main message. Types of prompts sent from the artificial intelligence response output apparatus 10010 to the large language model server 20001 include a setting prompt for storing instructions such as initial settings and a user prompt that reflect the instruction from the user. Type identification information that identifies whether the prompt is the setting prompt or the user prompt may be stored in a portion of the prompt other than its main message. When the character operation program of the artificial intelligence response output apparatus 10010 creates the prompt based on the text of the words spoken by the user 230, the user prompt is created and sent to the large language model server 20001.

Next, based on the prompt sent from the artificial intelligence response output apparatus 10010, the large language model which is artificial intelligence of the large language model server 20001 executes inference and generates a response including the natural language text information based on the inference result. The large language model server 20001 sends the response to the artificial intelligence response output apparatus 10010 using the API. Natural language text information is stored in the response as the main message. Here, the response may be metadata in which information written in the same format as the above-described prompt (e.g., format such as markup format using tags in a markup language, format using a predetermined symbol such as markdown format, or object format using a predetermined script such as JSON) is stored. In a case where the same format as the above-described prompt is used in the response, type identification information indicating that the above-described setting prompt and the user prompt are different types of information may be stored in a portion other than the main message. For example, information indicating that the response phrase is from the large language model may be stored.

Next, the artificial intelligence response output apparatus 10010 receives the response from the large language model server 20001, and extracts the natural language text information stored as the main message of the response. Based on the natural language text information extracted from the above-described response, the character operation program of the artificial intelligence response output apparatus 10010 generates natural language audio that serves as a response to the user using an audio synthesis technique, and outputs it from the audio output unit 1140 which is the speaker, so that it sounds as if it is the voice of a character 20051. This processing may be referred to as a “speech” of the character.

As described above, according to the first operation example of the artificial intelligence response output apparatus 10010 of FIG. 2C, or of the artificial intelligence response output system including the artificial intelligence response output apparatus 10010 and the large language model server 20001, it is possible to utilize advanced natural language processing capabilities of the large language model via the API, and thus, when the user speaks to the character, it is possible to respond to the user and converse with the user more suitably.

Next, another flow example of a series of operations (second operation example) of the artificial intelligence response output apparatus 10010 will be described.

### Second Operation Example

In the first operation example, actions performed by the user 230 for the artificial intelligence response output apparatus 10010 were mainly prompts by the voice of the user 230. In the first operation example, the series of operations were performed starting from the process of capturing the voice of the user 230 with the microphone. In contrast, in the second operation example, in addition to the artificial intelligence response output apparatus 10010 performing the series of operations starting from the process of capturing the voice of the user 230 with the microphone, the user 230 can perform actions for the artificial intelligence response output apparatus 10010 by the user operation via the operation input unit 1107 of FIG. 1B. Here, an example of the operation input unit 1107 of FIG. 1B includes a mouse, a keyboard, a touch panel, or the like.

In addition, in the second operation example, the user 230 can perform an action for the artificial intelligence response output apparatus 10010 by the touch operation of the user detectable by the touch operation input sensor of the display 10011 of FIG. 1B.

In addition, in the second operation example, the user 230 can operate the mobile information processing terminal 20010 to perform communication with the artificial intelligence response output apparatus 10010 from the mobile information processing terminal 20010 to allow the operation input of the user 230 to be input to the artificial intelligence response output apparatus 10010.

In addition, the display panel 20011 of the mobile information processing terminal 20010 may display an information storage image such as a two-dimensional code in which information that the user wishes to transmit to the artificial intelligence response output apparatus 10010 is stored, and the imager 1180 of the artificial intelligence response output apparatus 10010 of FIG. 1B may capture the display image. The controller 1110 of the artificial intelligence response output apparatus 10010 may extract the information from the information storage image such as the two-dimensional code captured by the imager 1180 to retrieve the information. In addition, the display panel 20011 of the mobile information processing terminal 20010 may display the image that the user wishes to transmit to the artificial intelligence response output apparatus 10010, and the imager 1180 of the artificial intelligence response output apparatus 10010 of FIG. 1B may capture the display image. The controller 1110 of the artificial intelligence response output apparatus 10010 may perform image recognition processing on the image captured by the imager 1180 to acquire a result of the image recognition processing.

In this manner, in the second operation example, the artificial intelligence response output apparatus 10010 has more actions that can be performed by the user 230 than the artificial intelligence response output apparatus 10010 of the first operation example. In this manner, in the second operation example, the artificial intelligence response output apparatus 10010 can acquire the result of the action by the user 230 other than the user's voice, and generate the prompt to be sent to the large language model server 20001 based on the result. In this manner, the prompt to be sent to the large language model server 20001 can suitably contain information of types other than the natural language text information extracted from the user's voice. Information of types other than the natural language text information extracted from the user's voice includes, for example, an image, video, audio, or the like.

Next, in the second operation example, the artificial intelligence response output apparatus 10010 sends the prompt to the large language model server 20001 using the API. In the present operation example also, the prompt may be metadata in which information such as format such as markup format using tags in a markup language, format using a predetermined symbol such as markdown format, or object format using a predetermined script such as JSON is stored. In the present operation example also, types of prompts include a setting prompt for storing instructions such as initial settings and a user prompt that reflect the instruction from the user. Type identification information that identifies whether the prompt is the setting prompt or the user prompt may be stored in a portion of the prompt other than its main message. At this time, the prompt contains the natural language text information as the main message. Further, in the present embodiment, it is possible to include the natural language text information and the non-natural language information source such as the image, video, or audio as information of the type other than the natural language text information in the main message of the prompt. The specific method for including the non-natural language information source in the prompt will be described below.

The large language model server 20001 has the multimodal large language model that can process the non-natural language information source together with the natural language text information. The large language model server 20001 receives the prompt from the artificial intelligence response output apparatus 10010. Based on the prompt, the multimodal large language model executes inference and generates a response including the natural language text information based on the inference result. Here, the artificial intelligence of the large language model server 20001 is the multimodal large language model, and thus, the response can include the natural language text information and the non-natural language information source such as the image, video, or audio.

The artificial intelligence response output apparatus 10010 receives the response from the large language model server 20001, and extracts the natural language text information stored as the main message of the response and the non-natural language information source such as the image, video, or audio. Based on the natural language text information extracted from the above-described response, the character operation program of the artificial intelligence response output apparatus 10010 may generate natural language audio that serves as a response to the user using the audio synthesis technique, and may output it from the audio output unit 1140 which is the speaker, so that it sounds as if it is the voice of the character 19051 displayed on the display screen.

In addition, based on the natural language text information extracted from the above-described response, the character operation program of the artificial intelligence response output apparatus 10010 may display natural language words which is the response to the user on the display screen of the artificial intelligence response output apparatus 10010. At this time, the words may be displayed with the character 19051, or may be displayed overlapping the image of the character 19051, or may be displayed instead of the image of the character 19051. Such a specific processing may be executed by the image controller 1160.

In addition, based on the information of the image of the non-natural language information source extracted from the above-described response, the character operation program of the artificial intelligence response output apparatus 10010 may display the image on the display screen of the artificial intelligence response output apparatus 10010 for the user. At this time, the image may be displayed with the character 19051, or may be displayed overlapping the image of the character 19051, or may be displayed instead of the image of the character 19051. Such a specific processing may be executed by the image controller 1160.

In addition, based on the information of the video of the non-natural language information source extracted from the above-described response, the character operation program of the artificial intelligence response output apparatus 10010 may display the video on the display screen of the artificial intelligence response output apparatus 10010 for the user. At this time, the video may be displayed with the character 19051, or may be displayed overlapping the image of the character 19051, or may be displayed instead of the image of the character 19051. Such a specific processing may be executed by the image controller 1160.

In addition, the character operation program of the artificial intelligence response output apparatus 10010 may output the audio generated based on the information of the audio of the non-natural language information source extracted from the above-described response to the audio output unit 1140 which is the speaker.

According to the second operation example of the artificial intelligence response output apparatus 10010 or the artificial intelligence response output system including the artificial intelligence response output apparatus 10010 and the large language model server 20001 described above with reference to FIG. 2C, it is possible to utilize advanced natural language processing and non-natural language information processing capabilities of the multimodal large language model via the API. In addition to the response based on the natural language text, a response based on the non-natural language information source can be provided in response to the action of the user toward the character, allowing a more suitable conversation.

### Operation Example

Next, an example of the operation of the artificial intelligence response output apparatus 10010 according to the second embodiment of the present invention will be described with reference to FIG. 2D. This is also a description of an example of the operation of the artificial intelligence response output system including the artificial intelligence response output apparatus 10010 and the large language model server 20001. Specifically, FIG. 2D shows examples of the natural language text of the main message of the prompt sent from the artificial intelligence response output apparatus 10010 to the large language model server 20001 and the non-natural language information source such as the image, and the natural language text of the main message of the server response which is the response to the prompt and the non-natural language information source such as the image. In the present embodiment, the non-natural language information source can use an image, video, audio, or the like. FIG. 2D shows an example of an image as the non-natural language information source. The series of operations or processing described with reference to the drawing may be controlled by cooperation between the client application 8010 and the server LLM application 8020 described with reference to FIG. 1E.

In addition, FIG. 2D shows the setting prompt and exchange of prompts and responses in chronological order from the first round of user prompt to the second round of user prompt and corresponding responses. Here, the prompts and responses shown in FIG. 2D include a non-natural language information source 20061 and a non-natural language information source 20062. In the example of FIG. 2D, the non-natural language information source 20061 and the non-natural language information source 20062 are both images.

In FIG. 2D, the image of the non-natural language information source 20061 is shown embedded in the prompt for simplicity. However, there are a plurality of methods for transmitting or specifying data from the non-natural language information source 20061 in the prompt sent from the artificial intelligence response output apparatus 10010 to the large language model server 20001. The artificial intelligence response output apparatus 10010 may use any one of the plurality of methods or switch between them as appropriate. Hereinafter, an example of each method will be described.

A first method for transmitting or specifying the non-natural language information source data in the prompt is used, for example, when the non-natural language information source to be specified is located on a server or the like connected to a network such as the Internet. A specific method of the first method is for specifying a non-natural language information source file on the network such as the Internet using information such as tags or symbols in the prompt by specifying a location information (such as URL) of and file name of the non-natural language information source file.

For example, using the tag <img src=“****”> which specifies an image in the markup language, the image on the network such as the Internet may be specified by entering the location information and file name information of the image file in the “****” portion. In addition, using the tag <video src=“****”> which specifies a video in the markup language, the video on the network such as the Internet may be specified by entering the location information and file name information of the video file in the “****” portion. In addition, using the tag <audio src=“****”> which specifies audio in the markup language, the audio on the network such as the Internet may be specified by entering the location information and file name information of the audio file in the “****” portion. In addition, in a case where the JSON format is used, a key such as “img_src” is made available, and the image on the network such as the Internet may be specified by entering the location information and file name information of the image file in a respective value. The key and the value may be respectively prepared for the video file or audio file. The specific format example provided is merely an example, and other custom formats may be used. In any case, the information specifying the location information and file name information of the non-natural language information source file may be stored in the prompt.

As in the first method, in a case where the information specifying the location information and file name information of the non-natural language information source file is stored in the prompt, there is no need to store data of the non-natural language information source file in the prompt itself. Therefore, the amount of data in the prompt can be reduced. In the first method, the large language model server 20001 receiving the prompt specified by the non-natural language information source data may use the location information and file name information of the non-natural language information source file stored in the prompt to acquire the non-natural language information source file located on the server or the like connected to the network such as the Internet.

Here, the method in which the artificial intelligence response output apparatus 10010 inputs the location information and file name information in a case where the non-natural language information source data in the prompt is specified in the first method will be described. In FIG. 2C, the types of actions that can be performed by the user 230 on the artificial intelligence response output apparatus 10010 in addition to the voice of the user 230 has been described. Therefore, for example, the user 230 may input the location information such as the URL for specifying the non-natural language information source data or the file name information by the user operation (such as the mouse, keyboard, touch panel) via the operation input unit 1107 of FIG. 1B.

In addition, in the artificial intelligence response output apparatus 10010, the controller 1110 may cooperate with the memory 1109 and execute a WEB browser program to display a GUI of the WEB browser program on the display screen of the artificial intelligence response output apparatus 10010. The user operation for the GUI of the WEB browser program may be received by the user's touch operation that can be detected by the user operation via the operation input unit 1107 (such as a mouse, keyboard, or touch panel) or the touch operation input sensor of the display 10011, and the non-natural language information source data such as the image, video, or audio selected in a browser screen of the WEB browser program may be set as data to be specified in the prompt. In this case, the WEB browser program may acquire the location information and file name information of the non-natural language information source data and carry it over to the character operation program.

In addition, the user 230 may operate the mobile information processing terminal 20010 to perform a communication with the artificial intelligence response output apparatus 10010 from the mobile information processing terminal 20010 to input the location information such as the URL for specifying the non-natural language information source data to the artificial intelligence response output apparatus 10010. In addition, the information storage image such as the two-dimensional code may be displayed on the display panel 20011 of the mobile information processing terminal 20010 as described with reference to FIG. 2C to perform the image recognition processing on the image captured by the imager 1180 of the artificial intelligence response output apparatus 10010 and to input the location information such as the URL and file name information for specifying the non-natural language information source data by acquiring the result of the image recognition processing.

Note that using the first method for transmitting or specifying the non-natural language information source data in the prompt is not limited to cases in which the non-natural language information source file is stored in advance on the server or the like connected to the network such as the Internet. For example, in a case where the non-natural language information source data such as the image, video, or audio stored in the storage 1170 of the artificial intelligence response output apparatus 10010 is to be included in the prompt, the artificial intelligence response output apparatus 10010 may upload the non-natural language information source data to the second server 19002 via the Internet 19000, and the prompt may include the location information on the Internet (such as the URL) and file name of the non-natural language information source data uploaded to the second server 19002. In this case, the second server 19002 functions as the so-called intermediate server.

Likewise, in a case where the non-natural language information source data such as the image, video, or audio stored in the storage 20016 of the mobile information processing terminal 20010 is to be included in the prompt, the mobile information processing terminal 20010 may upload the non-natural language information source data to the second server 19002 via the Internet 19000. The mobile information processing terminal 20010 or the second server 19002 may send the location information on the Internet (such as the URL) and file name of the non-natural language information source data from the second server 19002 to the artificial intelligence response output apparatus 10010, and the location information on the Internet (such as the URL) and file name of the non-natural language information source data acquired by the character operation program of the artificial intelligence response output apparatus 10010 and uploaded to the second server 19002 may be included in the prompt.

Further, the character operation program of the artificial intelligence response output apparatus 10010 may construct a media server in the artificial intelligence response output apparatus 10010 that can cooperate with the memory 1109 and the storage 1170 and can be accessed from other servers via the Internet 19000. In this case, in a case where the non-natural language information source data in the prompt is specified in the first method, the artificial intelligence response output apparatus 10010 may store, in the prompt, the location information on the Internet (such as the URL) indicating the media server constructed in the artificial intelligence response output apparatus 10010 itself and the file name of the corresponding non-natural language information source data.

Next, a second method for specifying the transmission or specifying of the non-natural language information source data in the prompt is, for example, a method in which the non-natural language information source data itself is simply stored in (attached to) the prompt. Generally, the non-natural language information source data such as the image, video, or audio has a larger data volume than the text information which is natural language. Therefore, in this case, the data volume of the prompt itself becomes larger than in the first method. The character operation program of the artificial intelligence response output apparatus 10010 temporarily stores the non-natural language information source data to be stored in (attached to) the prompt in the memory 1109, and when sending the prompt, may store (attach) the data in the prompt and output the data from the memory 1109 to the large language model server 20001 via the communication unit 1132. The non-natural language information source data itself stored in the memory 1109 by the character operation program of the artificial intelligence response output apparatus 10010 may be acquired by the communication unit 1132 via the Internet 19000, may be acquired from the mobile information processing terminal 20010 by the communication unit 1132, or may be read from the storage 1170 and stored in the memory 1109.

The above-described method makes it possible for the artificial intelligence response output apparatus 10010 to transmit or specify the non-natural language information source data by the prompt.

The large language model server 20001 is the multimodal large language model that can process the non-natural language information source together with the natural language text information, and thus, as shown in the example of FIG. 2D, based on the first round of user prompt, the server acquires the image including the swimming pool and the poolside which is the non-natural language information source 20061 and the text information which is natural language and outputs the text information which is natural language as the inference result in response to the first round of user prompt as shown in the drawing.

In addition, the large language model server 20001 is the multimodal large language model that can process the non-natural language information source together with the natural language text information, and thus, as shown in the example of FIG. 2D, based on the response to the second round of user prompt, the large language model server 20001 can include the non-natural language information source 20062 generated by inference of the multimodal large language model in the response and send it to the artificial intelligence response output apparatus 10010. FIG. 2D shows an example in which the non-natural language information source 20062 is an image with a circle added to the image of the swimming pool and the poolside which is the non-natural language information source 20061. Note that the non-natural language information source 20062 stored in the response is not limited to the image shown in FIG. 2D and may be any video or audio.

In the method where the non-natural language information source other than the natural language text information is included in the response from the large language model server 20001, a method that conforms to the first method or the second method in which the above-described artificial intelligence response output apparatus 10010 transmits or specifies the non-natural language information source data in the prompt may be used.

Specifically, as a method conforming to the above-described first method, the large language model server 20001 may store the information specifying the location information and file name information of the non-natural language information source file in the prompt as a response. The non-natural language information source 20062 itself such as the image, video, or audio may be held by the large language model server 20001 or may be transferred to the second server 19002 functioning as the intermediate server and be held there. In both cases, the large language model server 20001 may store the information specifying the location information and file name information of the non-natural language information source file in the prompt as a response. The artificial intelligence response output apparatus 10010 that has acquired the response may access the large language model server 20001 or the second server 19002 using the location information and file name information of the non-natural language information source file in the prompt to acquire the non-natural language information source 20062.

In addition, specifically, as a method conforming to the above-described second method, the large language model server 20001 may store (attach) file data itself of the non-natural language information source 20062 and send it to the artificial intelligence response output apparatus 10010 as a response. The artificial intelligence response output apparatus 10010 can acquire the data of the non-natural language information source 20062 stored in (attached to) the prompt to use it for various outputs to the user 230.

As described above with reference to FIG. 2D, according to the artificial intelligence response output apparatus 10010 and the operation of the artificial intelligence response output system according to the second embodiment, an exchange of prompts and responses for achieving a conversation using the image, video, or audio which is the non-natural language information is performed between the character displayed on the artificial intelligence response output apparatus 10010 and the user 230. In this manner, it is possible to achieve a more advanced and natural conversation as shown in the messages of FIG. 2D.

### Display Example

Next, a display example of the artificial intelligence response output apparatus 10010 according to the third second of the present invention will be described with reference to FIG. 2E. In the example of FIG. 2E, the response from the large language model for the prompt from the user described with reference to FIGS. 2A to 2D is displayed on the display 10011 of the artificial intelligence response output apparatus 10010. Specifically, FIG. 2E is an example in which the text 10063 of the natural language information source data which is the response from the large language model, the image 10064 of the non-natural language information source data, and/or the video 10065 of the non-natural language information source data are displayed on the display 10011 together with the image of the character 19051. The text 10063 which is the response from the large language model, the image 10064, and/or the video 10065 may be displayed overlapping the image of the character 19051 as shown in FIG. 2E.

In addition, the text 10063 which is the response from the large language model, the image 10064, and/or the video 10065 may be displayed together with the image of the character 19051 without overlapping the image of the character 19051. The display of FIG. 2E is merely an example. For example, in a case where the user 230 adjusts the volume of the audio output of the audio output unit 1140 of the artificial intelligence response output apparatus 10010 to its minimum or sets the audio output to OFF by operating the operation input unit 1107 or the touch operation input sensor of the display 10011, the user 230 will no longer be able to hear the response from the large language model. Thus, in this case, the controller 1110 may control a display mode to start displaying the text 10063 which is the response from the large language model, the image 10064, and/or the video 10065 together with the image of the character 19051 as shown in FIG. 2E.

This makes it possible for the user 230 to use the artificial intelligence response output apparatus 10010 when the user wishes to suppress the audio output. Note that a configuration may be provided in which the user 230 can manually switch the ON/OFF of the display mode that displays the text 10063 which is the response from the large language model, the image 10064, and/or the video 10065 together with the image of the character 19051 by the operation via the operation input unit 1107 or the touch operation input sensor of the display 10011. According to the display example of FIG. 2E, in the multimodal-compatible artificial intelligence response output apparatus 10010, it is possible to output a more suitable response from the large language model.

According to the artificial intelligence response output apparatus 10010 and artificial intelligence response output system according to the second embodiment, a more advanced conversation experience including the information regarding the natural language and non-natural language can be provided to the user using the multimodal large language model.

Note that, in the second embodiment, an example of using the large language model of the large language model server 20001 as the large language model has been described. Alternatively, the artificial intelligence response output apparatus 10010 may comprise the local LLM processor 10028 shown in FIG. 1B, and may use the multimodal large language model of the local LLM processor 10028. In this case, the multimodal large language model of the local LLM processor 10028 may be used instead of the multimodal large language model of the large language model server 20001. In this case, the operation or processing in the local LLM processor 10028 may be controlled by the local LLM application 8015 as described with reference to FIG. 1E.

In this case, in the above description of the second embodiment, the multimodal large language model of the large language model server 20001 may be read as the multimodal large language model of the local LLM processor 10028 of the artificial intelligence response output apparatus 10010. In this case also, a more advanced conversation experience including the information of the natural language and non-natural language can be provided to the user using the multimodal large language model.

Note that the term “character” as used in each embodiment of the present invention described above includes the concepts of AI assistants and avatars.

### Third Embodiment

Next, a third embodiment of the present invention will be described. In the present embodiment, only differences from the second embodiment or the third embodiment will be described, and descriptions of configurations similar to those of the embodiments will be omitted as appropriate. That is, in the figures of the present embodiment, components denoted by the same reference signs as those in the figures of the previously described embodiments have the same functions and configurations. For the sake of simplicity, such components will not be described repeatedly.

The third embodiment has a configuration in which a language model for response generation and output is combined with a retrieval-augmented generation (RAG) technique (RAG+LLM configuration). For RAG, the technique described in, for example, Reference 4 may be used.
[Reference 4]
   Patrick Lewis, et. al. “Retrieval-Augmented Generation for Knowledge-Intensive NLP Tasks”, https://arxiv.org/pdf/2005.11401v4

### [Regarding RAG]

RAG is a method that combines information retrieval with generative AI such as the LLM. In RAG, the data (sometimes referred to as original data) such as the text (strings), image, audio, or the like that is the basis of an information source/related information/knowledge collections (sometimes collectively referred to as knowledge base) is converted into a computer-understandable format through embedding. Specifically, there is provided a vectorization technique to convert the original data into a numerical vector. Types of embeddings include text embedding (word embedding, sentence embedding), image embedding, and audio embedding.

Embedded data obtained through embedding, particularly vectorized data/vector data, is used to analyze relationships and similarities between data. By applying cosine similarity between pieces of vectorized data (or numerical vectors), it is possible to calculate the similarity between the pieces of data. Regarding a query (user prompt) to the LLM, it is possible to search for highly relevant information (knowledge) from the knowledge base using the similarity between the pieces of data. In RAG, the search result from the knowledge base is combined with the query (user prompt) to generate a prompt for the LLM. This prompt is used to generate a response of the LLM.

In the RAG configuration, processing can be broadly classified into (1) data pre-processing (or pre-processing) and (2) retrieval-augmented generation (RAG) processing+response generation processing by the LLM. The former may also be referred to as a first processing, and the latter as a second processing.

The data pre-processing is processing for generating search data (also referred to as knowledge base data) from the collected original data by embedding processing and storing the generated data in the database (DB) or the like. In the data pre-processing, a processor divides the original data of the knowledge base (such as text) into appropriate sizes (also referred to as chunking) and measures the number of tokens. A chunk is data obtained by dividing information into appropriate units. The appropriate units are units that maintain meaning and fit within a context window of the LLM. In the data pre-processing, chunked data/chunk data is converted into embedded data (vectorized data/vector data) by embedding processing and is stored in the DB. In addition, the chunked data/chunk data is also stored in the DB. The chunked data/chunk data and the embedded data (vectorized data/vector data) obtained by performing embedding processing on the chunked data/chunk data are stored in the DB in association with each other. Such association is also referred to as indexing.

The search processing of RAG includes processing for searching a search DB based on the user prompt, obtaining search results, and generating prompt for an LLM by combining the user prompt with the knowledge base data. In the search processing of RAG, the processor searches (that is, performs vector search on) a knowledge base DB based on the user prompt which is a query input by a user. As a search result, knowledge data highly relevant to the query (also referred to as related information or related knowledge information) are obtained. The related knowledge information which is the search result is chunked data/chunk data determined to by highly relevant to the query. The processor adds the related knowledge information that is the search result from the knowledge base to the user prompt to create a prompt for the LLM. Then, the processor sends/inputs the prompt to the LLM, acquires a response as a result of inference by the LLM, and outputs the response to the user. Based on the prompt, the LLM executes inference and generates a response in which the related knowledge information (related information) is taken into consideration. In this manner, it becomes easier for the user to obtain a more suitable response that reflects the knowledge base (corresponding original data).

### [RAG Configuration]

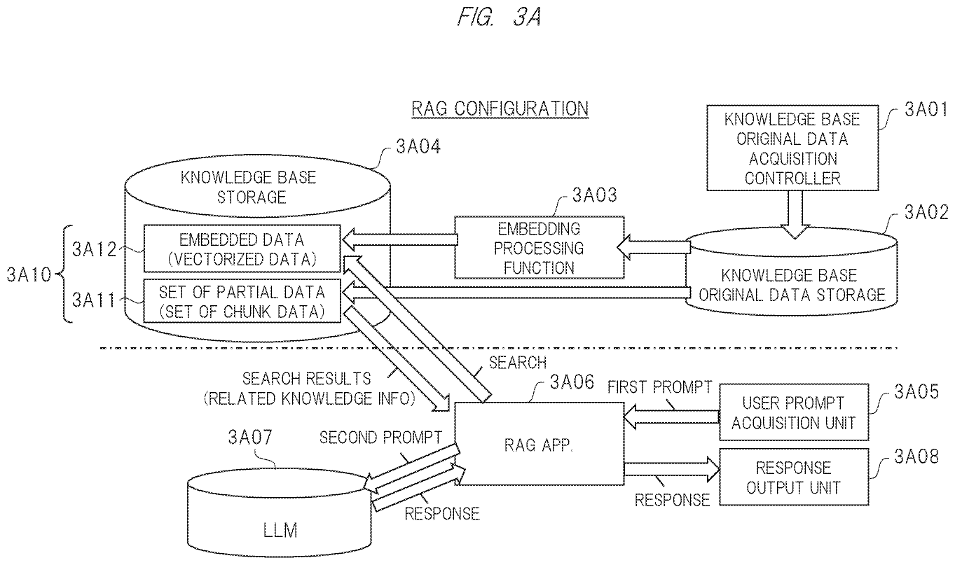

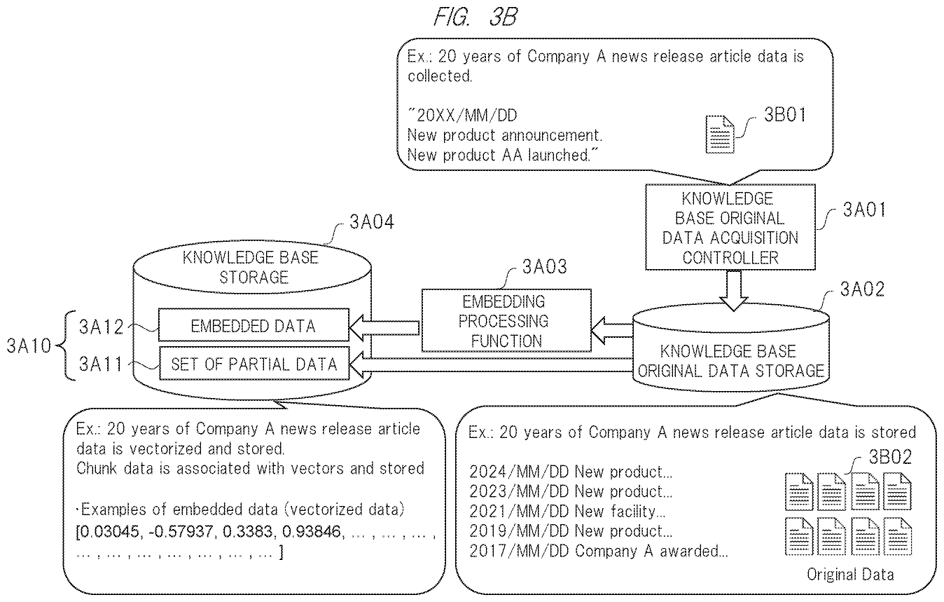

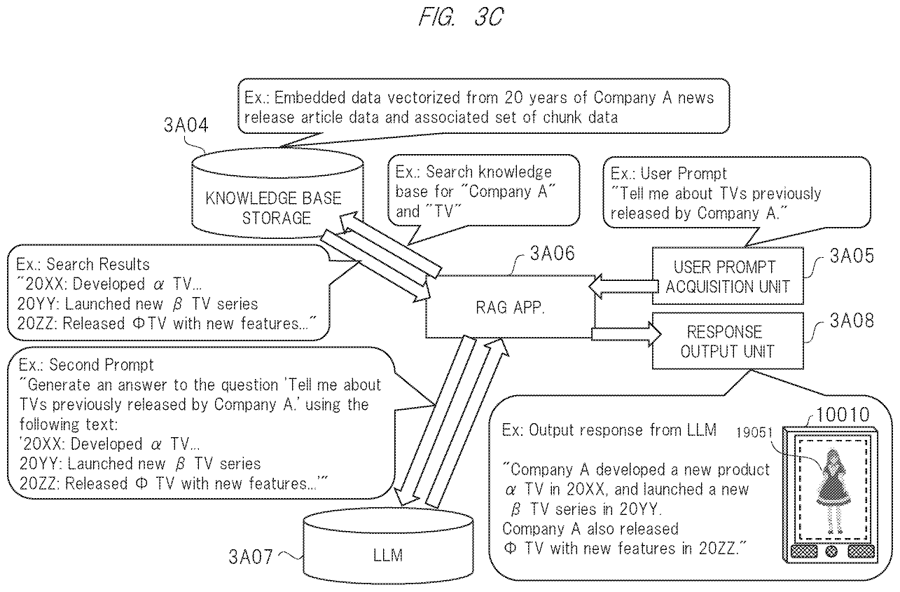

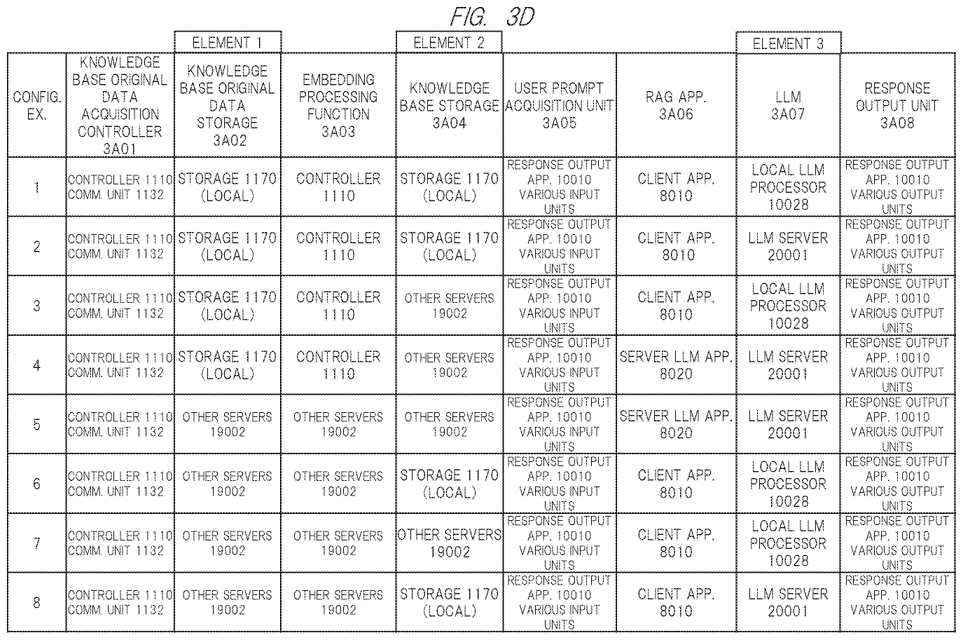

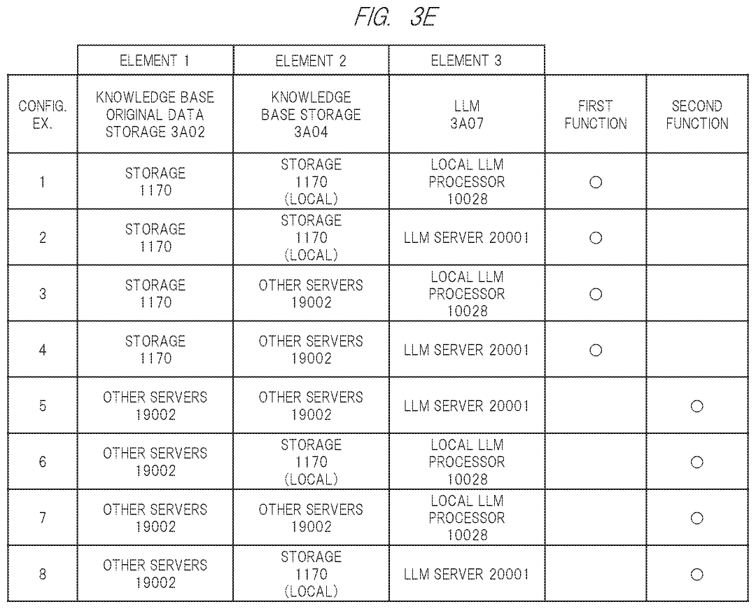

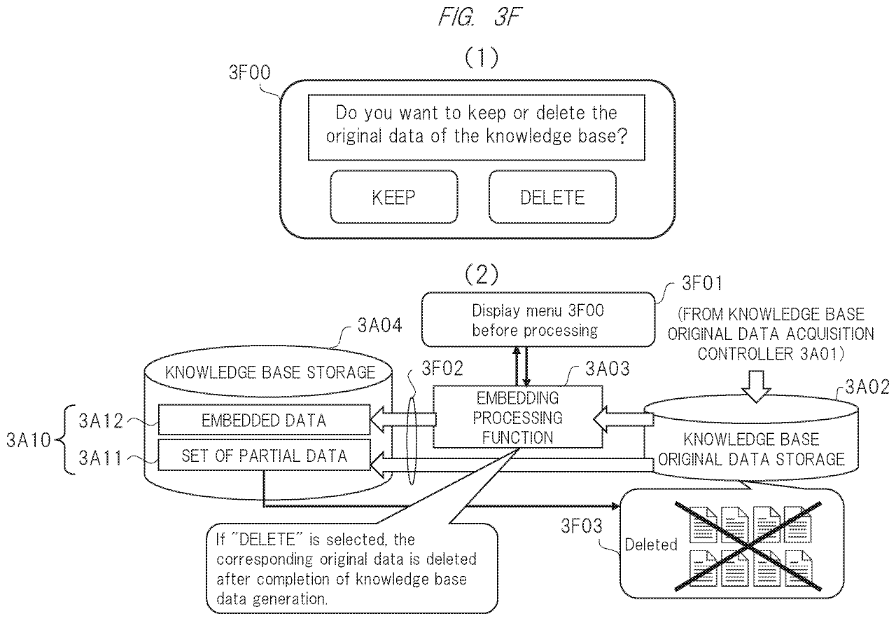

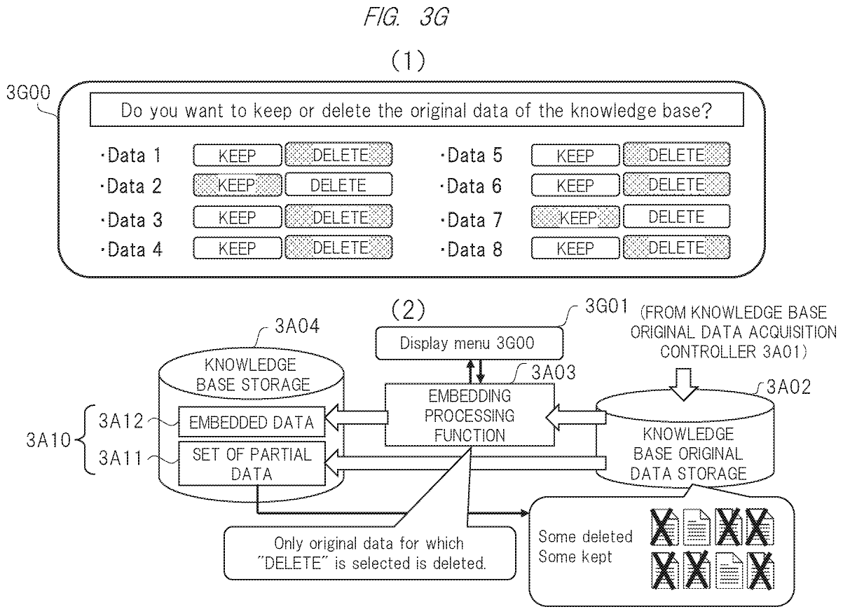

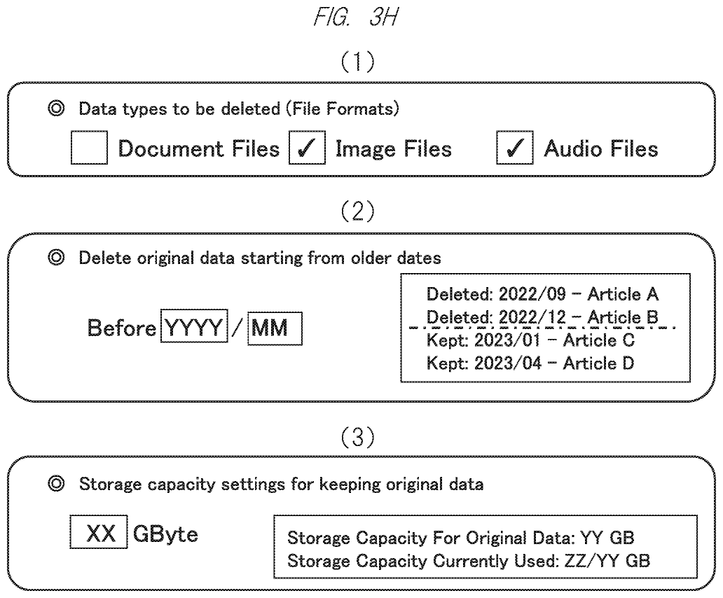

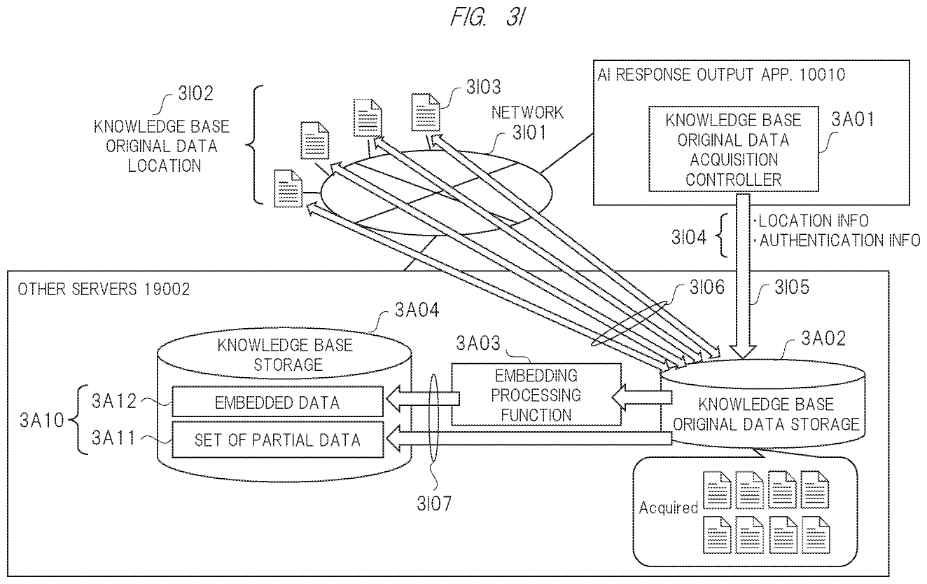

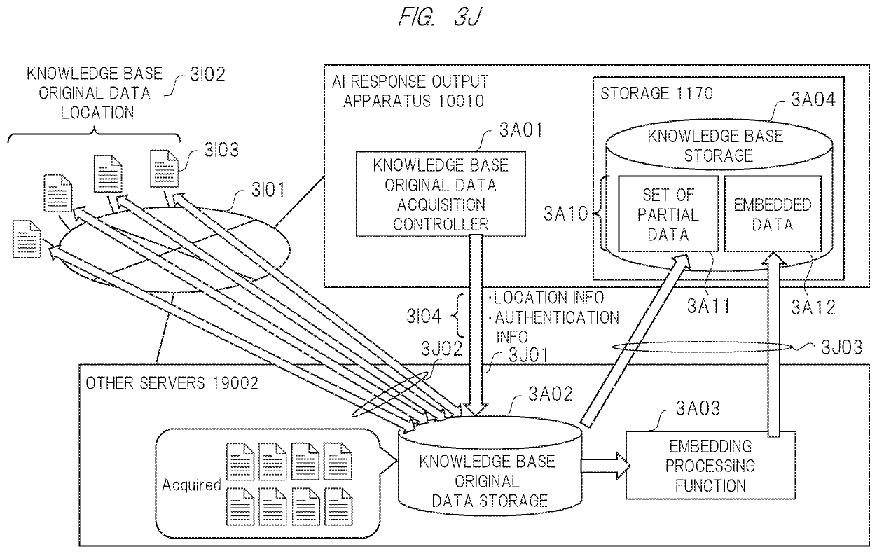

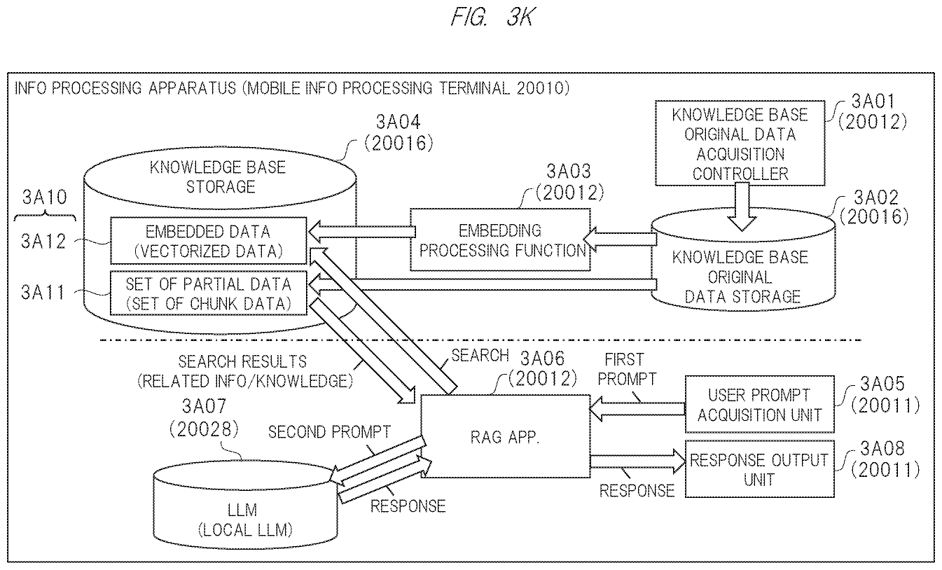

FIG. 3A is an explanatory diagram of a configuration of the RAG implemented in the system (AI response output system) including the artificial intelligence response output apparatus (AI response output apparatus) according to the third embodiment. FIG. 3A shows functional blocks for performing retrieval-augmented generation (RAG) processing in the response output system of the third embodiment. As described above, Processing and operations of the present system can be broadly classified, into (1) the first processing: data pre-processing, and (2) the second processing: retrieval-augmented generation (RAG) processing+response generation processing by the LLM. In FIG. 3A, components relating to the first processing are shown above a one-dot chain line, and components relating to the second processing are shown below the one-dot chain line (including a knowledge base storage 3A04).

The RAG configuration of FIG. 3A has a knowledge base original data acquisition controller 3A01, a knowledge base original data storage 3A02, an embedding processing function 3A03, a knowledge base storage 3A04, a user prompt acquisition unit 3A05, a retrieval-augmented generation (RAG) application 3A06, a large language model (LLM) 3A07, and a response output unit 3A08 as functional blocks.

The data pre-processing of (1) is processing for generating knowledge base data 3A10 (embedded data 3A12 and a set of partial data 3A11) by embedding processing based on the collected original data. The collected original data is stored in the knowledge base original data storage 3A02 (such as the storage DB). The generated knowledge base data 3A10 is stored in the knowledge base storage 3A04 (such as the storage DB).

The knowledge base data 3A10 includes embedded data (vectorized data) 3A12 and a set of partial data (a set of chunk data) 3A11, and these pieces of data are associated with each other. In the present embodiment, the embedded data 3A12 is vectorized data. The set of partial data 3A11 is the set of chunk data and is a plurality of pieces of partial data (chunk data) obtained by dividing the original data (such as text) into predetermined units corresponding to the original data.

In an upper portion of FIG. 3A, the knowledge base original data acquisition controller 3A01 collects the original data of the knowledge base and stores the collected original data in the knowledge base original data storage 3A02. The embedding processing function 3A03 reads the original data stored in the knowledge base original data storage 3A02 and performs embedding processing on the original data. In this manner, as the knowledge base data 3A10, the embedding processing function 3A03 generates the embedded data (vectorized data) 3A12 and the set of partial data (set of chunk data) 3A11 associated with the embedded data. The embedding processing function 3A03 stores the generated knowledge base data 3A10 in the knowledge base storage 3A04. The set of partial data (set of chunk data) 3A11 is a plurality of pieces of partial data (chunk data) that are divided from the original data and indexed so as to be associated with the embedded data 3A12.

The RAG processing+response generation processing by the LLM of (2) includes the following processing. The RAG processing includes processing for searching the knowledge base data 3A10 (embedded data 3A12 and set of chunk data 3A11) stored in the knowledge base storage 3A04 based on the prompt input by the user via the user interface (also referred to as user prompt or first prompt), particularly by vector search, and obtaining related knowledge information (related information) as a search result. The related knowledge information which is the search result is partial data (chunk data) 3A11 determined to be highly relevant to the prompt input by the user through a search using the embedded data 3A12. In addition, the RAG processing includes processing for generating a prompt (also referred to as second prompt) for the LLM 3A07 using the user prompt (first prompt) and the knowledge base data which is the search result.

The response generation processing by the LLM 3A07 includes processing for inputting/sending a second prompt to the LLM 3A07, processing in which the LLM 3A07 executes inference based on the second prompt to generate a response in which related knowledge information is taken into consideration, and processing for acquiring the generated response and outputting the response to the user via the user interface.

In a lower portion of FIG. 3A, the user prompt acquisition unit 3A05 acquires the user prompt (first prompt) input by the user via the user interface. Based on the user prompt (first prompt), the RAG application 3A06 searches the knowledge base data 3A10 (embedded data 3A12 and set of chunk data 3A11) stored in the knowledge base storage 3A04 (particularly by vector search), and obtains related knowledge information (related information) as a search result. The RAG application 3A06 generates the second prompt for the LLM 3A07 using the first prompt and the related knowledge information which is the search result. The RAG application 3A06 inputs/sends the second prompt to the LLM 3A07. Based on the second prompt, the LLM 3A07 generates, by inference, a response in which the related knowledge information is taken into consideration, and outputs/sends the generated response to the RAG application 3A06. The RAG application 3A06 transfers the response received/acquired from the LLM 3A07 to the response output unit 3A08. The response output unit 3A08 outputs the response to the user via the user interface.

When searching the knowledge base data 3A10 stored in the knowledge base storage 3A04, the RAG application 3A06 determines similarity between pieces of data using, for example, cosine similarity using the embedded data (numerical vector) based on the first prompt, and acquires data having close similarity (related knowledge information) as a search result. As the search result, the RAG application 3A06 particularly acquires partial data of the original data associated with the embedded data.

As the embedded data 3A12, the vector (vectorized data/numerical vector) may typically be used. In a case where the vector is used, embedding processing may employ vectorization processing. The embedded data is not limited thereto, and in addition to the vector, a tensor may also be used as the embedded data. In a case where the tensor is used, embedding processing may employ tensorization processing.

Note that the natural language data contained in the second prompt from the RAG application 3A06 to the LLM 3A07 may be appropriately converted into embedded data (such as a vector) between the RAG application 3A06 and the LLM 3A07.

Note that, in the second prompt, in a case where the non-natural language information source such as an image or audio is used in addition to the text, the LLM 3A07 is a multimodal language model capable of processing an image, audio, or the like.

### Description of Each Unit/Function of RAG and Hardware Implementation Examples

Descriptions of each unit/function of the RAG configuration of FIG. 3A and hardware implementation examples are as follows.

The knowledge base original data acquisition controller 3A01 performs control to acquire data (original data) that is the basis of knowledge (knowledge base data) to be subjected to retrieval augmentation in the retrieval-augmented generation (RAG) processing. As hardware for implementing the knowledge base original data acquisition controller 3A01, the controller 1110, the communication unit 1132, or the like of the artificial intelligence response output apparatus 10010 may be used. Note that the data that is the basis of knowledge (knowledge base data) is mainly text information such as linguistic information, but may also include multimodal non-linguistic information such as images, video, audio, and the like.

The knowledge base original data storage 3A02 is configured to store data that is the basis of knowledge (knowledge base data) acquired by the control of the knowledge base original data acquisition controller 3A01. As hardware for implementing the knowledge base original data storage 3A02, the storage 1170 of the artificial intelligence response output apparatus 10010, a storage (not shown) on another server 19002, the storage 22020 of the large language model server 20001, or the like may be used.

The embedding processing function 3A03 is a function/structural component that performs embedding processing on data that is the basis of knowledge (knowledge base data) acquired by the control of the knowledge base original data acquisition controller 3A01 and stored in the knowledge base original data storage 3A02. Through embedding, the data can be converted into data (embedded data 3A12) that can be used at high speed in the retrieval-augmented generation (RAG) processing. The embedding is performed per partial data (chunk data). Implementation of the embedding processing function 3A03 may be achieved by, for example, the controller 1110 of the response output apparatus 10010 executing an embedding processing program stored in the memory 1109. As another example of implementation of the embedding processing function 3A03, a controller of the other server 19002 may execute an embedding processing program stored in a memory (not shown) of the other server 19002.

The knowledge base storage 3A04 stores, in association with each other, the set of partial data (set of chunk data) 3A11 obtained by dividing the data that is the basis of knowledge (knowledge base data) stored in the knowledge base original data storage 3A02, and the embedded data (vectorized data) 3A12 obtained by embedding each set of partial data (set of chunk data) 3A11 by the embedding processing function 3A03, to configure the knowledge base (knowledge base data 3A10). The set of partial data (set of chunk data) 3A11 may include, in the case of natural language, words, sentences, or the like, and in the case of non-natural language, images, audio, or the like. The embedded data 3A12 which is vectorized data may also be referred to as a vector store. As hardware for implementing the knowledge base storage 3A04, the storage 1170 of the artificial intelligence response output apparatus 10010, a storage (not shown) of the other server 19002, the storage 22020 of the large language model server 20001, or the like may be used.

The user prompt acquisition unit 3A05 acquires the prompt input by the user. As hardware for implementing the user prompt acquisition unit 3A05, various input units of the artificial intelligence response output apparatus 10010 described in the above embodiments may be used. Specifically, the touch operation input sensor of the display 10011, the microphone 1139, the operation input unit 1107, the imager 1180, and the like may be used. In addition, the artificial intelligence response output apparatus 10010 may acquire the prompt input by the user from the mobile information processing terminal 20010 or another terminal or server via the communication unit 1132.

Based on the user prompt (first prompt) acquired by the user prompt acquisition unit 3A05, the retrieval-augmented generation (RAG) application 3A06 searches for information relating to the content of the user prompt from the knowledge base data 3A10 stored in the knowledge base storage 3A04. In this search (particularly vector search), the embedded data (vectorized data) 3A12 stored in the knowledge base storage 3A04 is compared with the embedded data (vectorized data) representing the content of the user prompt, and the embedded data having a high degree of similarity is retrieved. Specifically, cosine similarity or the like may be used to determine the degree of similarity. The embedded data 3A12 (vector) having a high degree of similarity to the embedded data (vector) corresponding to the content of the user prompt is identified from among the embedded data 3A12 stored in the knowledge base storage 3A04. Then, the partial data (chunk data) associated with the identified embedded data 3A12 from among the set of partial data (set of chunk data) 3A11 may be used as related knowledge information (related information) which is the search result.

Note that it is possible to refer to the partial data from the vectorized data based on association using an index. In a case where the search result is natural language, the result data may be in units such as words or sentences. In a case where the original data of the knowledge base includes not only natural language but also multimodal non-linguistic information, the search result may include multimodal non-linguistic information such as an image, video, or audio.

Based on the user prompt acquired by the user prompt acquisition unit 3A05 and the related knowledge information which is partial data (chunk data) obtained as a search result from the knowledge base data 3A10 stored in the knowledge base storage 3A04, the RAG application 3A06 generates the second prompt to be input to the LLM 3A07, and inputs/sends the second prompt to the LLM 3A07. For example, the second prompt includes the partial data (chunk data) in addition to the user prompt.

As hardware for implementing the RAG application 3A06, in a case where the local LLM processor 10028 (FIG. 1B) is used as the LLM, it is preferable to implement the RAG application 3A06 in the client application 8010 (FIG. 1E). This is because it is more efficient for the client application 8010 to perform input and output of information with the local LLM processor 10028. In addition, in a case where the storage 1170 of the artificial intelligence response output apparatus 10010 is used as the knowledge base storage 3A04, it is preferable to implement the RAG application 3A06 in the client application 8010. This is because it is more efficient for the client application 8010 to perform a search on the knowledge base data stored in the storage 1170. Note that, in a case where a server-side LLM is used as the large language model 3A07, and the knowledge base storage 3A04 is also provided on the server side, the RAG application 3A06 may be implemented as the server LLM application 8020 (FIG. 1E).

As hardware for implementing the LLM 3A07, the local LLM processor 10028 of the response output apparatus 10010 described in the previous embodiments may be used, or the large language model of the LLM server 20001 may be used. The LLM 3A07 may be a language model serving as a foundation model as described in the previous embodiments. For example, it may be a language model trained on natural language. For example, it may be a multimodal language model trained on not only natural language but also non-natural language information. The language model may be a large-scale language model, a medium-scale language model, or a small-scale language model. In the present embodiment, a large-scale language model is described as an example.

In the response output system that performs the retrieval-augmented generation processing, the large language model 3A07 performs inference and generates a response using, as input, the second prompt generated by the RAG application 3A06. The second prompt is generated based on the user prompt (first prompt) acquired by the user prompt acquisition unit 3A05 and on the search result obtained from the data stored in the knowledge base storage 3A04. The response generated by the LLM 3A07 is sent to the response output unit 3A08 via the RAG application 3A06 or the like.

The response output unit 3A08 outputs, to the user, the response generated by inference executed by the LLM 3A07 based on the second prompt. Hardware for implementing the response output unit 3A08 may include various output units of the response output apparatus 10010. Specifically, examples include display by the display 10011, audio output from the audio output unit 1140, and output from the communication unit 1132 to the mobile information processing terminal 20010 used by the user 230.

### [RAG Data Pre-Processing]

FIG. 3B is an explanatory diagram of an example of RAG data pre-processing in the RAG configuration implemented in the system including the artificial intelligence response output apparatus according to the third embodiment. For example, the knowledge base original data acquisition controller 3A01 collects, as an example of original data, document files 3B01 of company articles (such as of Company A which may be the company itself), such as a plurality of document files 3B01 of news release articles over a predetermined period (such as the past 20 years), and stores them in the knowledge base original data storage 3A02 (such as the storage DB). An example of an article includes text such as “20XX/XX/XX: New Product Announcement. New product AA launched.”

In a case where an instruction/setting is provided to generate a knowledge base, the embedding processing function 3A03 executes embedding processing for generating original data 3B02 (such as article document files for the past 20 years) stored in the knowledge base original data storage 3A02. Through embedding processing from the original data 3B02 (each document file 3B01), the embedding processing function 3A03 generates the embedded data (vectorized data) 3A12 and corresponding set of partial data (set of chunk data) 3A11 and stores them as the knowledge base data 3A10 in the knowledge base storage 3A04.

In this manner, in the knowledge base storage 3A04 (such as the storage DB), article data for the past 20 years (original data 3B02) are stored in the form of embedded data 3A12 and corresponding set of partial data 3A11. An example of the vectorized data as the embedded data 3A12 is a multi-dimensional numerical vector such as [0.03045, −0.57937, 0.3383, 0.93846, . . . , . . . , . . . , . . . , . . . , . . . , . . . , . . . , . . . , . . . ].

Since the original data 3B02 is data collected to create the embedded data 3A12 for the RAG, the original data 3B02 is basically unnecessary after the embedded data 3A12 is generated and stored. In other words, for the purposes and functions of the RAG in the second processing, it is sufficient to have the DB of the knowledge base storage 3A04, and therefore, the original data 3B02 in the knowledge base original data storage 3A02 is, in principle, not used in the second processing.

### RAG+LLM: Conversation Examples

FIG. 3C is an explanatory diagram of an example of a conversation (queries and responses) with the LLM using the RAG in the system including the artificial intelligence response output apparatus according to the third embodiment. An example of the user prompt (first prompt) input by the user is, in text form, “Tell me about TVs previously released by Company A.” The RAG application 3A06 converts the user prompt into embedded data using, for example, words such as “Company A” and “TVs”, and searches (that is, performs vector search on) the DB of the knowledge base storage 3A04. As related knowledge information (related information) obtained as a result of this search, partial data (chunk data) in the form of an article (text) such as “20XX: Developed α TV . . . ,” “20YY: Launched new β TV series,” and “20ZZ: Released φ TV with new features . . . ” is obtained.

The RAG application 3A06 generates the second prompt using the user prompt and the related knowledge information (related information) obtained as the search result. An example of the second prompt in text form is: “Generate an answer to the question ‘Tell me about TVs previously released by Company A.’ using the following text: ‘20XX: Developed α TV . . . ,’ ‘20YY: Launched new β TV series,’ ‘20ZZ: Released φ TV with new features . . . ’.” That is, a new second prompt is generated using the user prompt and the partial data (chunk data) which is the related knowledge information (related information).

An example of the response generated by the LLM 3A07 in response to the second prompt in text form is: “Company A developed a new product a TV in 20XX, and launched a new β TV series in 20YY. Company A also released φ TV with new features in 20ZZ.” The response output unit 3A08 outputs the response from the LLM 3A07 on the user interface. For example, the character 19051 displayed on the screen of the display 10011 of the response output apparatus 10010 may speak this response in audio form or display it as text.

Note that the search results of the knowledge base data 3A10 may include multiple items of information, with each partial data item being treated as a single unit. The RAG application 3A06 may reduce or limit the number of pieces to a predetermined number through a selection processing using predetermined conditions before generating the second prompt. Examples of such predetermined conditions include selecting a predetermined number of items in descending order of cosine similarity. Another example of predetermined conditions includes selecting a predetermined number of items starting from those with smaller data sizes among the related knowledge information (related information) obtained as the search results.

### Configuration Examples

FIG. 3D is an explanatory diagram in which multiple configuration examples relating to the arrangement of components of the RAG and the LLM in the system including the artificial intelligence response output apparatus according to the third embodiment are summarized in a table.

In the table of FIG. 3D, eight configuration examples are shown row by row as Configuration Examples 1 to 8. The columns of the table indicate, as components, the structural components shown in FIG. 3A (from the knowledge base original data acquisition controller 3A01 to the response output unit 3A08). Each configuration example represents an example of how each structural component is arranged and implemented in which part of the system. As main components in the description of the system configuration examples, Element 1, Element 2, and Element 3 are provided. Element 1 is the knowledge base original data storage 3A02, Element 2 is the knowledge base storage 3A04, and Element 3 is the LLM 3A07. The options for Elements 1, 2, and 3 are broadly classified into arrangement on the local side (in other words, the terminal side or the response output apparatus 10010 side) or arrangement on the server side (in other words, external to the response output apparatus 10010). In the present embodiment, “local” refers to the response output apparatus 10010.

Element 1 concerns whether the original data is stored on the local side or on the server side. Element 2 concerns whether the knowledge base data (including embedded data) is stored on the local side or on the server side. Element 3 concerns whether the LLM is placed on the local side or on the server side. Different configuration examples exist depending on the combinations of these elements.

First, elements that are common among the configuration examples will be described. The knowledge base original data acquisition controller 3A01 is implemented by the controller 1110 and the communication unit 1132 of the response output apparatus 10010. The user prompt acquisition unit 3A05 is implemented by various input units of the response output apparatus 10010. For example, a configuration similar to that used for input of the user prompt in the first embodiment or the second embodiment described above may be used. The response output unit 3A08 is implemented by various output units of the response output apparatus 10010. For example, a configuration similar to that used for the response output in the first embodiment or the second embodiment described above may be used.

### Configuration Example 1: Local/Local/Local

Configuration Example 1 adopts a combination of local/local/local for Elements 1, 2, and 3. In Configuration Example 1, the knowledge base original data storage 3A02 of Element 1 is arranged and implemented in the storage 1170 (local) of the response output apparatus 10010. That is, the original data is arranged locally. The embedding processing function 3A03 is arranged and implemented in the controller 1110 of the response output apparatus 10010. The knowledge base storage 3A04 of Element 2 is arranged and implemented in the storage 1170 (local) of the response output apparatus 10010. That is, the knowledge base data is arranged locally. The RAG application 3A06 is arranged and implemented in the client application 8010 of the response output apparatus 10010. The LLM 3A07 of Element 3 is arranged and implemented in the local LLM processor 10028 of the response output apparatus 10010. That is, the LLM 3A07 is arranged locally (as a local LLM).

Configuration Example 1 requires a high processing capability and a large storage capacity in the response output apparatus 10010 which is the local terminal. Configuration Example 1 does not require a network (Internet) connection during operation. Since the knowledge base data 3A10 (embedded data 3A12 and set of chunk data 3A11) is also stored in the local storage, Configuration Example 1 is more secure. By using the local LLM, Configuration Example 1 can generate a response more securely than the server-side LLM of the LLM server 20001, and enables the most secure operation of response generation using RAG+LLM.

### Configuration Example 2: Local/Local/Server

Configuration Example 2 adopts a combination of local/local/server for Elements 1, 2, and 3. Configuration Example 2 differs from Configuration Example 1 in that the LLM 3A07 of Element 3 is arranged and implemented in the LLM server 20001.

Configuration Example 2 requires a high processing capability and a large storage capacity in the response output apparatus 10010 which is the local terminal. In order to operate response generation using RAG+LLM, Configuration Example 2 requires that the response output apparatus 10010 be connected to a network (Internet) and be in a state capable of connecting to the LLM server 20001. Configuration Example 2 can use the server-side LLM of the LLM server 20001 which is expected to have higher performance than the local LLM.

### Configuration Example 3: Local/Server/Local

Configuration Example 3 adopts a combination of local/server/local for Elements 1, 2, and 3. Configuration Example 3 differs from Configuration Example 1 in that the knowledge base storage 3A04 of Element 2 is arranged and implemented in the other servers 19002.

Configuration Example 3 requires a high processing capability in the response output apparatus 10010 which is the local terminal. In Configuration Example 3, since the knowledge base data 3A10 (embedded data 3A12 and set of chunk data 3A11) does not need to be stored in the local terminal, storage capacity at the local terminal can be saved. In order to operate response generation using RAG+LLM, Configuration Example 3 requires that the response output apparatus 10010 be connected to a network (Internet) and be in a state capable of connecting to various servers. By using the local LLM, Configuration Example 3 can generate a response more securely than the server-side LLM of the LLM server 20001.

### Configuration Example 4: Local/Server/Server

Configuration Example 4 adopts a combination of local/server/server for Elements 1, 2, and 3. Configuration Example 4 differs from Configuration Example 3 in that the LLM 3A07 of Element 3 is arranged and implemented in the LLM server 20001. In addition, the RAG application 3A06 is arranged and implemented in the server LLM application 8020.

Configuration Example 4 requires a high processing capability in the local terminal. In Configuration Example 4, since the knowledge base data 3A10 does not need to be stored in the local terminal, storage capacity at the local terminal can be saved. In order to operate response generation using RAG+LLM, Configuration Example 4 requires that the response output apparatus 10010 be connected to a network (Internet) and be in a state capable of connecting to various servers. Configuration Example 4 can use the server-side LLM of the LLM server 20001, which is expected to have higher performance than the local LLM.

### Configuration Example 5: Server/Server/Server

Configuration Example 5 adopts a combination of server/server/server for Elements 1, 2, and 3. Configuration Example 5 differs from Configuration Example 4 in that the knowledge base original data storage 3A02 of Element 1 is arranged and implemented in the other servers 19002.

Configuration Example 5 does not require a high processing capability in the response output apparatus 10010 which is a local terminal. In Configuration Example 5, since neither the original data nor the knowledge base data 3A10 is stored in the local terminal, the local terminal does not need to have a large storage capacity. In order to increase security during operation, Configuration Example 5 requires the other server 19002 that stores the knowledge base data 3A10 to be secure. Configuration Example 5 also requires the LLM server 20001 to be secure. In order to operate response generation using RAG+LLM, Configuration Example 5 requires that the response output apparatus 10010 be connected to a network (Internet) and be in a state capable of connecting to various servers. Configuration Example 5 can use the server-side LLM of the LLM server 20001 which is expected to have higher performance than the local LLM.

### Configuration Example 6: Server/Local/Local

Configuration Example 6 adopts a combination of server/local/local for Elements 1, 2, and 3. Configuration Example 6 differs from Configuration Example 1 in that the knowledge base original data storage 3A02 of Element 1 is arranged and implemented in the other servers 19002.

Configuration Example 6 does not require a high processing capability in the response output apparatus 10010 which is the local terminal. Configuration Example 6 requires storage capacity in the local terminal. In Configuration Example 6, since the knowledge base data 3A10 is also stored in the storage of the local terminal after completion of generation of the knowledge base data 3A10, Configuration Example 6 is more secure. By using the local LLM, Configuration Example 6 can generate a response more securely than the server-side LLM of the LLM server 20001, and enables secure operation of response generation using RAG+LLM. Configuration Example 6 does not require a network (Internet) connection during operation of response generation using RAG+LLM.

### Configuration Example 7: Server/Server/Local

Configuration Example 7 adopts a combination of server/server/local for Elements 1, 2, and 3. Configuration Example 7 differs from Configuration Example 6 in that the knowledge base storage 3A04 of Element 2 is arranged and implemented in the other servers 19002.

Configuration Example 7 does not require high processing capability in the local terminal. In Configuration Example 7, since neither the original data nor the knowledge base data 3A10 is stored in the local terminal, the local terminal does not need to have a large storage capacity. In order to increase security during operation, Configuration Example 7 requires the other server 19002 that stores the knowledge base data 3A10 be secure. In order to operate response generation using RAG+LLM, Configuration Example 7 requires that the response output apparatus 10010 be connected to a network (Internet) and be in a state capable of connecting to various servers. By using a local LLM, Configuration Example 7 can generate responses more securely than the server-side LLM of the LLM server 20001.

### Configuration Example 8: Server/Local/Server

Configuration Example 8 adopts a combination of server/local/server for Elements 1, 2, and 3. Configuration Example 8 differs from Configuration Example 5 in that the knowledge base storage 3A04 of Element 2 is arranged and implemented in the storage 1170 of the response output apparatus 10010.

Configuration Example 8 does not require a high processing capability in the local terminal. In Configuration Example 8, the local terminal requires storage capacity sufficient to store the knowledge base data 3A10. Configuration Example 8 can use the server-side LLM of the LLM server 20001 which is expected to have higher performance than the local LLM. In order to operate response generation using RAG+LLM, Configuration Example 8 requires that the response output apparatus 10010 be connected to a network (Internet) and be in a state capable of connecting to the LLM server 20001. Configuration Example 8 may be effective, for example, when the knowledge base data 3A10 cannot be stored on the server side.

As described above, in the system including the artificial intelligence response output apparatus according to the third embodiment, response generation using RAG+LLM can be operated under various configurations such as those shown in Configuration Examples 1 to 8 described above.

### Issues and the Like

Next, issues such as data management relating to the configuration examples of the above-described RAG+LLM will be described.

### Regarding Configuration Examples 1 and 2

In Configuration Examples 1 and 2, both the knowledge base original data and the knowledge base data 3A10 (embedded data 3A12 and set of chunk data 3A11) are stored in the storage 1170 of the artificial intelligence response output apparatus 10010. Alternatively, two or more storage apparatuses including a storage for storing the knowledge base original data and a storage for storing the knowledge base data 3A10 are required. In such a case, there is an issue in that a large portion of the capacity of the storage 1170 is occupied. That is, the storage capacity (storage usage) becomes large, and the processing load of the artificial intelligence response output apparatus 10010 which is the local terminal becomes high. Thus, there are issues in terms of storage capacity, processing efficiency, and the like. In particular, when the artificial intelligence response output apparatus 10010 is the mobile information processing terminal 20010 (FIG. 2A, etc.) such as the user's smartphone, this issue becomes especially significant because the storage capacity of the mobile information processing terminal 20010 is limited, that is, relatively small.

In Configuration Examples 1 and 2, in order to save storage capacity on the local terminal, it is preferable to display, during the embedding processing, a menu that allows the user to select management (deleting or keeping) of the original data that is present outside the knowledge base after the embedding processing, that is, after generation of the knowledge base data (first function described below).

### Regarding Configuration Examples 3 and 4

In Configuration Examples 3 and 4, the original data that is not used in the RAG and that is present outside the knowledge base data 3A10 remains stored in the storage 1170 of the artificial intelligence response output apparatus 10010. As a result, there is an issue in that the capacity of the storage 1170 on the local terminal is consumed. In particular, in a case where the artificial intelligence response output apparatus 10010 is the mobile information processing terminal 20010 such as the user's smartphone, this issue becomes especially significant because the storage capacity is limited.

Similarly to Configuration Examples 1 and 2, in Configuration Examples 3 and 4, in order to save storage capacity on the local terminal, it is preferable to display, during the embedding processing, a menu that allows the user to select management (deleting or keeping) of the original data that is present outside the knowledge base after the embedding processing, that is, after generation of the knowledge base data (first function described below). However, unlike Configuration Examples 1 and 2, the knowledge base data 3A10 in Configuration Examples 3 and 4 is stored on the server side. Accordingly, there may be more available storage capacity on the local terminal than in Configuration Examples 1 and 2. However, since the original data is not used when performing response generation processing by RAG processing+LLM, keeping the original data in principle results in waste of storage capacity. Therefore, it is preferable to delete the original data after generation of the knowledge base data.

### Regarding Configuration Examples 5 to 8

In Configuration Examples 5 to 8, the original data is stored on the server side (other servers 19002). However, if it is necessary to use or pass through the storage of the response output apparatus 10010 which is a local terminal when acquiring the original data and storing it on the server side, the storage capacity is consumed accordingly, and a processing load is also imposed. In Configuration Examples 5 to 8, it is preferable to minimize use of and save the capacity of the storage 1170 on the local terminal when acquiring and storing the knowledge base original data. Therefore, in Configuration Examples 5 to 8, it is preferable that, during acquisition control of the knowledge base original data, the original data is not stored in or passed through the storage 1170 of the response output apparatus 10010. In particular, it is preferable to provide a mechanism in which the server side (other servers 19002) acquires the original data from the location of the original data and stores it in the server-side storage (second function described below). This mechanism will be described below.

The table of FIG. 3E shows examples of whether or not the first function and the second function are implemented for Configuration Examples 1 to 8 of FIG. 3D. For example, for Configuration Examples 1 to 4, the first function is indicated as implemented (marked with a circle). For Configuration Examples 5 to 8, the second function is indicated as not implemented (marked with circle). As another example, the first function may also be implemented for Configuration Examples 5 to 8 (marked with a circle). This is because there may be cases in which it is also necessary to appropriately reduce storage capacity on the server.

### [First Function: Menu Display for Confirming Deletion of Original Data]

In the present embodiment, the first function proposes deletion of the original data 3B02 to the user after generation of the knowledge base data 3A10. During the embedding processing, the first function outputs to the user, for example, a menu for confirming whether to delete or keep the original data 3B02 after generation of the knowledge base data 3A10. The timing at which this menu is output may be at the time of execution of the embedding processing, or at the time of user settings, system settings, instruction input, or the like regarding the embedding processing.

Note that the original data 3B02 stored in the knowledge base original data storage 3A02 may be kept without being deleted even after the knowledge base data 3A10 has been generated, allowing the user to normally utilize the original data 3B02, such as referring to the original data 3B02. Therefore, the first function in the present embodiment outputs to the user a menu allowing the user to select whether to delete or keep the original data 3B02 after generation of the knowledge base data 3A10.

FIG. 3F is an explanatory diagram showing a first example of displaying the screen relating to embedding processing (displaying the menu for confirming deletion of the original data) by the first function in the system including the artificial intelligence response output apparatus according to the third embodiment. As in Configuration Examples 1 to 4 of FIG. 3E, in a case where the knowledge base original data storage 3A02 is the storage 1170 of the response output apparatus 10010 which is the local terminal, data management processing by the first function is performed. The first function is implemented in the embedding processing function 3A03 (controller 1110 or other servers 19002).

The present system has a function (first function) of displaying, during the embedding processing, a GUI (graphical user interface) such as the menu for management of the original data after embedding processing (in particular, deleting or keeping the original data). In other words, the first function allows the user, based on the user's determination and operation, to select whether to delete or keep the original data for which embedding processing has been performed to generate the knowledge base data including the embedded data for the RAG. During the embedding processing, the embedding processing function 3A03 (controller 1110 or other servers 19002) displays, in the user interface, the menu for inquiring whether to delete or keep the original data, for example, before start of the embedding processing.

The timing at which the menu is displayed may be at the time of execution of the embedding processing, or at the time of system settings or user settings regarding the embedding processing. In the present embodiment, the embedding processing function 3A03 displays the menu at the time of execution of the embedding processing, for example, before the start of processing. The timing at which the menu is displayed is not limited to before the start of the embedding processing, and may be after completion of the embedding processing.

(1) in FIG. 3F shows a display example of a menu 3F00 on the user interface (such as the screen of the display 10011 of FIG. 1A). (2) in FIG. 3F correspondingly shows operations of structural components relating to RAG data pre-processing, such as the embedding processing function 3A03. Before starting embedding processing on the original data stored in the knowledge base original data storage 3A02, the embedding processing function 3A03 displays the menu 3F00 to the user (menu display step 3F01).

In the menu 3F00, for example, a message such as “Do you want to keep or delete the original data of the knowledge base?” is displayed, together with a “KEEP” button and a “DELETE” button. The user views the menu 3F00 and decides whether to keep or delete the original data. If the user decides to keep the original data, the user selects the “KEEP” button. If the user decides to delete the original data, the user selects the “DELETE” button.

If the “KEEP” button is selected, the embedding processing function 3A03 executes embedding processing on the original data stored in the knowledge base original data storage 3A02 to generate the knowledge base data 3A10 including the embedded data 3A12 (embedding processing step 3F02) and performs a control such that the original data is kept without being deleted.

If the “DELETE” button is selected, the embedding processing function 3A03 executes embedding processing on the original data stored in the knowledge base original data storage 3A02 to generate the knowledge base data 3A10 including the embedded data 3A12 and stores the generated knowledge base data 3A10 in the knowledge base storage 3A04 (embedding processing step 3F02). Thereafter, the embedding processing function 3A03 performs a control to delete the corresponding original data stored in the knowledge base original data storage 3A02 (original data deletion step 3F03). At this time, deletion of the original data is executed without requiring any user operation after completion of the embedding processing. Therefore, the user does not need to wait for completion of embedding processing to manually delete the original data, thereby improving usability.

When the original data is deleted, the storage usage relating to the knowledge base original data storage 3A02 can be reduced. When the original data is kept, the user can normally utilize the original data.

In a case where the timing at which the menu 3F00 is displayed is set to after completion of the embedding processing, the operation is as follows. At an instructed or set timing, the embedding processing function 3A03 executes embedding processing on the original data stored in the knowledge base original data storage 3A02 to generate the knowledge base data 3A10 including the embedded data 3A12 and stores the generated data in the knowledge base storage 3A04. The embedding processing requires a certain amount of time. Thereafter, the embedding processing function 3A03 displays the menu 3F00 to the user. If “DELETE” is selected and pressed in the menu 3F00, the embedding processing function 3A03 deletes the corresponding original data stored in the knowledge base original data storage 3A02.

In a case where the timing at which the menu 3F00 is displayed is set at the time of user settings, the operation is as follows. When the user performs user settings relating to the RAG, the system displays the menu 3F00 as one of the user setting menus. In the menu 3F00, the user selects and sets, for example, “DELETE.” At an instructed or set timing, the embedding processing function 3A03 executes embedding processing on the original data stored in the knowledge base original data storage 3A02 to generate the knowledge base data 3A10 including the embedded data 3A12 and stores the generated data in the knowledge base storage 3A04. Then, the embedding processing function 3A03 confirms the user setting information, and if the setting is “DELETE,” deletes the corresponding original data stored in the knowledge base original data storage 3A02. In this manner, by setting the timing at which the menu 3F00 is displayed to the user setting timing, that is, before the embedding processing, the user can complete the setting operation for deleting or keeping the original data in advance without waiting for completion of the embedding processing.

FIG. 3G is an explanatory diagram showing a second example of displaying on the screen relating to embedding processing by the first function (displaying the menu for confirming deletion of the original data). FIG. 3G shows an example in which a GUI that differs from the GUI of FIG. 3F is provided. This GUI allows the user to individually select and specify, for each of the pieces of data constituting the original data, whether to keep or delete the data. In a menu 3G00 of (1) in FIG. 3G, a “KEEP” button and a “DELETE” button are provided for each piece of data in the original data (such as Data 1 to Data 8). In practice, the illustrated Data 1 and the like may be displayed as a file name, a thumbnail, detailed information, or the like. The buttons with dot patterns indicate examples of buttons selected and pressed by the user. In the illustrated example, “KEEP” is selected for Data 2 and Data 7, and “DELETE” is selected for the other data. In this manner, the user can adjust whether to delete or keep each piece of data in the original data.

(2) in FIG. 3G shows operations of the embedding processing function 3A03 and the like corresponding to displaying on the menu 3G00 in (1). During embedding processing, the embedding processing function 3A03 displays the menu 3G00 (menu display step SG01). After generation of the knowledge base data 3A10, the embedding processing function 3A03 deletes only the original data for which “DELETE” has been selected in the menu 3G00, among the original data stored in the knowledge base original data storage 3A02. The individual pieces of data remaining in the knowledge base original data storage 3A02 can be normally utilized later by the user.

Note that, in the initial display of the menu 3G00, a default selection state for each piece of data may be set such that the “KEEP” button is selected (ON state). Conversely, in the initial display of the menu 3G00, the default selection state for each piece of data may be set such that the “DELETE” button is selected (ON state).

As another GUI, a GUI may be provided that allows the user to collectively select multiple pieces of data to be deleted, or multiple pieces of data to be kept, among the original data stored in the knowledge base original data storage 3A02. As an example of such a GUI, multiple file icons may be displayed in parallel on the screen, and range selection or the like may be accepted.

FIG. 3H is an explanatory diagram showing another example of displaying on the screen related to embedding processing (displaying the menu for confirming deletion of the original data) by the first function. FIG. 3H shows examples of other GUIs. As another GUI, a GUI that accepts selection of the data type (such as file format) relating to the original data may be provided. For example, an image file format or the like can be selected and specified as the data type to be deleted. (1) in FIG. 3H shows an example in which selection of data types (such as file formats) to be deleted in a menu is accepted. For example, for each data type such as document files, image files, and audio files, whether to delete or keep the data can be selected using check marks.

As another GUI, a GUI that accepts selection of dates and times or periods related to the original data may be provided. For example, dates and times or periods to be deleted can be selected and specified. For example, the original data that is older than a date and time specified by the user may be deleted sequentially. (2) in FIG. 3H shows an example in which, a threshold date (such as year and month) can be selected in a menu such that the original data is deleted starting from older dates. The pieces of original data for periods prior to the date (year and month) specified by the user are deleted.

As another GUI, a GUI that allows setting a storage capacity to be reserved for keeping the original data may be provided. (3) in FIG. 3H shows an example in which the storage capacity for keeping original data can be specified in units such as gigabytes in a menu. Information on the storage capacity reserved and set for the original data and the storage capacity currently in use can also be confirmed.

The embedding processing function 3A03 deletes a portion of the original data stored in the knowledge base original data storage 3A02 and keeps another portion thereof so as to satisfy the conditions specified and set in (2) or (3) in FIG. 3H.

As described above, according to the first function, prompting the user to select whether to delete or keep the original data of the knowledge base makes it possible to more suitably avoid a situation in which the original data of the knowledge base remains in the storage of the local terminal without the user's intention and thereby consume the storage capacity of the local terminal.

### [Second Function: Original Data Acquisition Control Processing]

FIGS. 31 and 3J are explanatory diagrams showing a first example relating to original data acquisition control processing performed by the second function in the system including the artificial intelligence response output apparatus according to the third embodiment. As in Configuration Examples 5 to 8 of FIG. 3E, in a case where the knowledge base original data storage 3A02 is arranged and implemented on the server side (other servers 19002), data management processing by the second function is performed. The second function is implemented in the knowledge base original data acquisition controller 3A01 (the controller 1110 and communication unit 1132 of the response output apparatus 10010). This second function is utilized in a case where the original data is initially located outside the response output apparatus 10010, for example, on a network 3101.

FIG. 3I shows a case where the first example relating to original data acquisition control processing by the second function is applied to Configuration Examples 5 and 7 of FIG. 3E. In Configuration Examples 5 and 7, the knowledge base original data storage 3A02 and the knowledge base storage 3A04 are both located on the server side (other servers 19002).

In the system configuration shown in FIG. 3I, the response output apparatus 10010 and the other servers 19002 are connected via the network 3I01 (such as the Internet). There is provided a knowledge base original data location 3102 on the network 3101. A specific example of this location is a server or the like identified by a URL or the like, but the location is not limited thereto. That is, in this example, original data 3103 such as document files or image files is stored on any server on the network 3101.

The second function is a mechanism in which the other server 19002 acquires the original data 3103 of the knowledge base initially located external to the response output apparatus 10010 which is the local terminal(knowledge base original data location 3102) without passing through the storage 1170 (local) of the response output apparatus 10010, and stores the acquired data in the knowledge base original data storage 3A02. In this second function, the knowledge base original data acquisition controller 3A01 of the response output apparatus 10010 notifies the other server 19002 of location information identifying the knowledge base original data location 3102, and the other server 19002 (such as the controller of other servers 19002) acquires the original data 3103 without passing through the storage 1170 (local). In this manner, the original data is not stored even temporarily in the storage (storage 1170) of the local terminal, thereby reducing the required storage capacity of the local terminal. In addition, in a case where the response output apparatus 10010 is the user's smartphone or the like, communication may be subject to metered billing or data volume limits imposed by a carrier. In such a case, bypassing the response output apparatus 10010 when acquiring the original data provides a significant user benefit by reducing communication charges incurred by the communication unit 1132.

In FIG. 3I, during control for collecting the original data, the knowledge base original data acquisition controller 3A01 sends and notifies the other server 19002 of information 3104 including location information (such as URL) for each piece of original data 3103 so that the other server 19002 can acquire the knowledge base original data 3103 without passing through the storage 1170 of the response output apparatus 10010 (information notification step 3I05). In this manner, the knowledge base original data acquisition controller 3A01 can specify the original data to the other server 19002.

The other server 19002 receives and acquires the information 3104 from the knowledge base original data acquisition controller 3A01. Based on the acquired location information, the controller of the other server 19002 collects and acquires the original data 3103 of the knowledge base from the knowledge base original data location 3102 on the network 3I01 (original data acquisition step 3I06). At this time, the storage 1170 or the like of the local terminal is not involved. For example, the other server 19002 accesses a server identified by a URL or the like, requests the original data 3103, and this server sends the original data 3103 to the other server 19002 as a response.

The other server 19002 stores the original data 3103 acquired from the specified location in the knowledge base original data storage 3A02 (storage held and managed by the other server 19002).

In addition, accessing the knowledge base original data location 3102 from the other server 19002 may require authentication information. In such a case, the information 3104 notified from the knowledge base original data acquisition controller 3A01 to the other server 19002 may include authentication information in addition to the location information for each piece of original data. The other server 19002 acquires the authentication information, and when accessing the location such as a server specified by the location information (original data acquisition step 3I06), successfully performs authentication with that location using the authentication information, and acquires the original data 3103.

Thereafter, the embedding processing function 3A03 in the other server 19002 performs embedding processing on the original data stored in the knowledge base original data storage 3A02, and stores the knowledge base data 3A10 including the embedded data 3A12 in the knowledge base storage 3A04 (storage held and managed by the other server 19002) (knowledge base data generation processing step 3I07).

FIG. 3J shows, as a second example of original data acquisition control processing by the second function, a case applied to Configuration Examples 6 and 8 of FIG. 3E. Configuration Examples 6 and 8 have a configuration in which the knowledge base original data storage 3A02 is located on the server side (other server 19002), and the knowledge base storage 3A04 is located on the local side (storage 1170 of the response output apparatus 10010).

In FIG. 3J, during control for collecting the original data, the knowledge base original data acquisition controller 3A01 sends and notifies the other server 19002 of the information 3104 including the location information relating to the original data 3103 (information notification step 3J01). The other server 19002 receives and acquires the information 3104 from the knowledge base original data acquisition controller 3A01. A controller or the like of the other server 19002 collects and acquires the original data 3103 of the knowledge base from the knowledge base original data location 3102 on the network 3I01 described in the acquired location information (original data acquisition step 3J02). At this time, the storage 1170 or the like of the local terminal is not involved. The other server 19002 stores the original data 3103 acquired from the specified location in the knowledge base original data storage 3A02 (storage held and managed by the other server 19002).

Thereafter, the embedding processing function 3A03 in the other server 19002 performs embedding processing on the original data stored in the knowledge base original data storage 3A02, and stores the knowledge base data 3A10 including the embedded data 3A12 in the knowledge base storage 3A04 (storage 1170) of the response output apparatus 10010 (knowledge base data generation processing step 3J03). At this time, the response output apparatus 10010 receives and acquires the knowledge base data 3A10 from the other server 19002 via the communication unit 1132 and stores the knowledge base data 3A10 in the knowledge base storage 3A04 (storage 1170).

As described above, according to the second function, when acquiring the original data, it does not pass through the storage of the response output apparatus 10010 which is the local terminal. Therefore, storage capacity usage and processing load on the local terminal can be reduced.

### [Implementation in a Mobile Terminal]

FIG. 3K shows, as one configuration example in the third embodiment, a configuration example in which the response output apparatus 10010 is the user's mobile information processing terminal 20010 (such as the smartphone). This configuration example corresponds to Configuration Example 1 of FIG. 3D, and the first function is implemented in the mobile information processing terminal 20010. Each unit such as the knowledge base original data acquisition controller 3A01, the embedding processing function 3A03, and the RAG application 3A06 is implemented by the controller 20012 (FIG. 2B) or the like of the mobile information processing terminal 20010. The knowledge base original data storage 3A02 and the knowledge base storage 3A04 are implemented in the storage 20016 of the mobile information processing terminal 20010. The local LLM which is the LLM 3A07 is implemented in the local LLM processor 20028 of the mobile information processing terminal 20010. The first function is implemented by the controller 20012 or the like of the mobile information processing terminal 20010.

In the case where the information processing apparatus has a relatively limited storage capacity such as in the mobile information processing terminal 20010, the effect of saving storage capacity by the first function is significant. In a case where the second function is implemented in the mobile information processing terminal 20010, the response output apparatus 10010 in FIG. 3I or 3J may be understood as being replaced with the mobile information processing terminal 20010. In this case also, the effect of saving storage capacity by the second function is significant.

As in the configuration example of FIG. 3K, the RAG+LLM system of the present embodiment can be implemented in any information processing apparatus such as the mobile information processing terminal 20010. A system configuration is possible in which at least a part of each unit of FIG. 3A is implemented in any information processing apparatus, such as the mobile information processing terminal 20010.

According to the above-described response output system of the third embodiment of the present invention, by combining the retrieval-augmented generation with the response generation and output configuration using the language model, it is possible to provide a system with improved usability.

In addition, the technique described in the present embodiment makes it possible to provide more suitable artificial intelligence response output technique. Such an artificial intelligence response output technique is expected to be introduced into infrastructure that is of higher quality and more reliable. As this technique is introduced into infrastructure, it will contribute to economic development and human welfare by prioritizing affordable and equitable access for all people. This will contribute to the United Nations' Sustainable Development Goals (SDGs) “9: Build resilient infrastructure, promote inclusive and sustainable industrialization, and foster innovation.”

In addition, the technique of the present embodiment makes it possible to provide a more suitable artificial intelligence response output technique. Such an artificial intelligence response output technique is expected to be introduced into public transportation facilities to improve accessibility to transportation systems for people in vulnerable positions. The introduction of this technique into public transportation systems is expected to contribute to improving traffic safety through the expansion of public transportation systems, as well as realizing access to sustainable transportation systems that are safe, affordable, and easily accessible to all people. This will contribute to the United Nations' Sustainable Development Goals (SDGs) “11: Sustainable Cities and Communities”.

The above describes various embodiments in detail. However, the present invention is not limited to the embodiments described above and includes various modifications. For example, the above-described embodiments are detailed descriptions of the entire system for the purpose of clearly explaining the present invention and are not necessarily limited to having all the described configurations. Furthermore, it is possible to replace part of the configuration of one embodiment with the configuration of another embodiment, and it is also possible to add the configuration of another embodiment to the configuration of one embodiment. Additionally, it is possible to add, delete, or replace part of the configuration of each embodiment with other configurations.

What is claimed is:

1. An information processing method executed by a system configured to perform information processing for retrieval-augmented generation, the method including:
an original data storage step of acquiring original data for retrieval-augmented generation and storing the acquired original data in an original data storage;
a knowledge base generation step of performing embedding processing for retrieval-augmented generation based on the original data stored in the original data storage to generate knowledge base data including embedded data, and storing the knowledge base data in a knowledge base storage to generate a knowledge base;
a selection information output step of outputting, to a user, selection information that allows the user to select whether to delete or keep the original data stored in the original data storage after the embedding processing; and
a control step of controlling deleting or keeping the original data stored in the original data storage based on a selection made by the user with respect to the selection information.

2. The information processing method according to claim 1,
wherein the knowledge base data stored in the knowledge base storage includes the embedded data and partial data obtained by dividing the original data, the embedded data and the partial data being stored in association with each other, and
wherein the method further includes a response output step of: acquiring a first prompt input by the user; based on the first prompt, searching the knowledge base data stored in the knowledge base storage to acquire a search result; generating a second prompt by using the first prompt and the search result; inputting the second prompt to a language model; acquiring a response as a result of inference by the language model; and outputting the response to the user.

3. The information processing method according to claim 1,
wherein, in a case where control is performed to delete the original data stored in the original data storage based on the selection made by the user with respect to the selection information, a timing at which the original data is deleted is a timing after the embedding processing is performed.

4. The information processing method according to claim 1,
wherein a timing at which the selection information is output is a timing after the embedding processing is performed.

5. The information processing method according to claim 1,
wherein a timing at which the selection information is output is a timing before the embedding processing is performed.

6. The information processing method according to claim 1,
wherein the selection information includes a graphical user interface that allows the user to select, for each piece of data among the original data, whether to delete or keep the data.

7. The information processing method according to claim 1,
wherein the selection information includes a graphical user interface that allows specification of a data type, a date, or a storage capacity for determining the original data to be deleted or kept.

8. The information processing method according to claim 1,
wherein the original data storage and the knowledge base storage are arranged in an information processing apparatus that is capable of outputting a response from a language model and that utilizes retrieval-augmented generation.

9. The information processing method according to claim 1,
wherein the original data storage is arranged in an information processing apparatus that is capable of outputting a response from a language model and that utilizes retrieval-augmented generation, and
wherein the knowledge base storage is arranged on a server external to the information processing apparatus.

10. An information processing apparatus related to retrieval-augmented generation, comprising:
an original data acquisition controller configured to acquire original data for retrieval-augmented generation and store the original data in an original data storage;
an embedding processor configured to perform embedding processing for retrieval-augmented generation based on the original data stored in the original data storage and to perform embedding processing to generate embedded data used for retrieval-augmented generation;
an output unit configured to output, to a user, selection information that allows the user to select whether to delete or keep the original data stored in the original data storage after generation of the embedded data; and
a controller configured to control deleting or keeping the original data stored in the original data storage based on the selection made by the user with respect to the selection information.

11. The information processing apparatus according to claim 10, further comprising a knowledge base storage configured to store knowledge base data for retrieval-augmented generation including the embedded data,
wherein, in the knowledge base data stored in the knowledge base storage, the embedded data and partial data obtained by dividing the original data are stored in association with each other, and
wherein the information processing apparatus is configured to: acquire a first prompt input by the user; based on the first prompt, search the knowledge base data stored in the knowledge base storage to acquire a search result; generate a second prompt by using the first prompt and the search result; input the second prompt to a language model; acquire a response as a result of inference by the language model; and output the response to the user.

12. The information processing apparatus according to claim 10,
wherein the information processing apparatus is a mobile information processing terminal.

13. An information processing method executed by a processor and related to retrieval-augmented generation, including:
an original data acquisition control step of controlling acquisition of original data for retrieval-augmented generation; and
a knowledge base generation step of: based on the original data acquired by controlling acquisition in the original data acquisition control step and stored in an original data storage, performing embedding processing for retrieval-augmented generation to generate knowledge base data including embedded data; and storing the knowledge base data in a knowledge base storage to generate a knowledge base,
wherein the original data storage is arranged on a server external to an information processing apparatus having the processor, and
wherein, in the original data acquisition control step, the information processing apparatus is configured to notify the server of location information of the original data such that the server acquires the original data and stores the original data in the original data storage without passing through the information processing apparatus and without storing the original data in the information processing apparatus.

14. The information processing method according to claim 13,
wherein the knowledge base data stored in the knowledge base storage includes the embedded data and partial data obtained by dividing the original data, the embedded data and the partial data being stored in association with each other, and
wherein the method further includes a response output step of: acquiring a first prompt input by a user of the information processing apparatus; searching the knowledge base data stored in the knowledge base storage based on the first prompt to obtain a search result; generating a second prompt using the first prompt and the search result; inputting the second prompt to a language model; acquiring a response as a result of inference by the language model; and outputting the response to the user.

15. The information processing method according to claim 13,
wherein, in the original data acquisition control step,
the information processing apparatus notifies the server of authentication information required to access the original data, and
the server accesses the original data based on the authentication information.

16. The information processing method according to claim 13,
wherein the knowledge base storage is arranged on the server.

17. The information processing method according to claim 13,
wherein the knowledge base storage is arranged in the information processing apparatus.

18. An information processing apparatus related to retrieval-augmented generation, comprising:
an original data acquisition controller configured to control acquiring original data for retrieval-augmented generation and storing the original data in an original data storage; and
an embedding processor configured to perform embedding processing for retrieval-augmented generation based on the original data stored in the original data storage and to perform embedding processing to generate embedded data used for retrieval-augmented generation,
wherein the original data storage is arranged on a server external to the information processing apparatus, and
wherein the original data acquisition controller is configured to notify the server of location information of the original data such that the server acquires the original data and stores the original data in the original data storage without passing through the information processing apparatus and without storing the original data in the information processing apparatus.

19. The information processing apparatus according to claim 18,
wherein the information processing apparatus is a mobile information processing terminal.
